(19) United States
(12) Patent Application Publication
(10) Pub. No.: US 2008/0172596 A1
(43) Pub. Date: Jul. 17, 2008

(54) SYSTEMS, METHODS AND APPARATUS FOR MULTIMEDIA DOCUMENT INTERCHANGE ARCHITECTURE BETWEEN HETEROGENEOUS COMPUTER SYSTEMS

(75) Inventor: Dave Weidner, Spokane Valley, WA (US)

Correspondence Address: RAMIREZ & SMITH, PO BOX 341179, AUSTIN, TX, 78734, US

(73) Assignee: ACCURATE DATA PLAN SERVICE, Spokane Valley, WA (US)

(21) Appl. No.: 11/966,932

(22) Filed: Dec. 28, 2007

Related U.S. Application Data
(60) Provisional application No. 60/882,903, filed on Dec. 29, 2006.

(51) Int. Cl. G06F 17/00

(52) U.S. Cl. 715/209; 715/201; 715/210

(57) ABSTRACT

Systems, methods and apparatus are provided through which multimedia objects that include design specifications are completed, aggregated, reviewed and distributed among computers in a heterogeneous network.

### RELATED APPLICATION

This application claims the benefit of U.S. Provisional Application Ser. No. 60/882,903 filed Dec. 29, 2006 under 35 U.S.C. 119(e).

This application is related to copending U.S. application Ser. No. 10/649,419 filed Aug. 26, 2003 entitled “METHOD FOR INTEGRATING DRAWINGS AND SUPPORTING DOCUMENTS USING GRAPHIC OBJECT INTERFACE.”

### FIELD OF THE INVENTION

This invention relates generally to an architecture of multimedia document exchange between computer systems, and more particularly to managing status of multimedia design documents between heterogeneous computer systems.

### BACKGROUND OF THE INVENTION

In conventional systems of managing documents, the documents are passed from one party to another across heterogeneous computer systems. Quite often the chain of custody of the documents starts with a number of initial entities between heterogeneous computer systems, who generate documents, who in turn pass or forward the documents between heterogeneous computer systems to one or more entities who attach the documents in one grouping, who in turn pass or forward the documents between heterogeneous computer systems to one or more reviewing entities, that comment on the documents, and who in turn pass or forward the reviewed documents to the initial entities and/or the aggregators.

The organization of the multimedia documents across heterogeneous computer systems is extraordinarily confusing. The nature and description of the multimedia documents is difficult to ascertain by either a computer-implemented process or an animate entity. As a result, the workflow of documents from one location to another can be convoluted, disorganized, delayed, erroneous and sometimes the entire process is not completed.

For the reasons stated above, and for other reasons stated below which will become apparent to those skilled in the art upon reading and understanding the present specification, there is a need in the art to improve the organization and architecture of workflow of multimedia objects between heterogeneous computer systems.

### BRIEF DESCRIPTION OF THE INVENTION

The above-mentioned shortcomings, disadvantages and problems are addressed herein, which will be understood by reading and studying the following specification.

In one aspect, a method to prepare project information for exchange in a predetermined architecture of multimedia object interchange includes receiving project documentation to a computer-accessible medium, receiving at least one multimedia object to the computer-accessible medium, and combining the at least one multimedia object with the project documentation.

In another aspect, a method to exchange graphic documents includes adding job-specific information to a plurality of graphic documents, the plurality of graphic documents having a file name in accordance with a standardized documentation nomenclature, the adding being performed upon each of the plurality of graphic documents by a materials originator; wherein the plurality of graphic documents are added by a plurality of material originators, aggregating the plurality of graphic documents into a folder data structure, the folder data structure being on a computer-accessible medium, and the aggregating being performed by an aggregator, determining a disposition of each of the plurality of graphic documents in reference to the job-specific information in each of the plurality of graphic documents, and delivering each of the disposed plurality of graphic documents and the disposition of each of the disposed plurality of graphic documents to the one of the plurality of material originators that added the job-specific information to the graphic document.

In yet another aspect, a method to prepare project information for exchange in a predetermined architecture of graphic document interchange includes receiving project documentation to a computer-accessible medium, receiving at least one graphic document to the computer-accessible medium, adding job-specific information to a plurality of graphic documents, the plurality of graphic documents having a file name in accordance with a standardized documentation nomenclature, the adding being performed upon each of the plurality of graphic documents by a materials originator, wherein the plurality of graphic documents are added by a plurality of material originators, and determining a disposition of each of the plurality of graphic documents in reference to the job-specific information in each of the plurality of graphic documents.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a system to exchange project information in a predetermined architecture of multimedia object interchange;

FIG. 2 is a block diagram of an overview of a method to exchange project information in a predetermined architecture of multimedia object interchange;

FIG. 3 is a flowchart of a method of receiving project documentation, according to an embodiment;

FIG. 4 is a flowchart of a method to exchange graphic documents, according to an embodiment;

FIG. 5 is a flowchart of a method to deliver disposed graphic documents and the disposition of the graphic documents, according to an embodiment;

FIG. 6 is a flowchart of a method to deliver disposed graphic documents and the disposition of the graphic documents, according to an embodiment;

FIG. 7 is a flowchart of a method to add job-specific information to the plurality of graphic documents, according to an embodiment;

FIG. 8 is a flowchart of a method to aggregate a plurality of graphic documents, according to an embodiment;

FIG. 9 is a flowchart of a method to direct the processor to determine the disposition of each of the plurality of graphic documents, according to an embodiment;

FIG. 10 is a flowchart of a method to associate the disposition with the graphic document, according to an embodiment;

FIG. 11 is a flowchart of a method to deliver the folder associated with rejection disposition and the folder associated with acceptance disposition, according to an embodiment;

FIG. 12 is a flowchart of a method to deliver the folder associated with rejection disposition and the folder associated with acceptance disposition, according to an embodiment;

FIG. 13 is a flowchart of a method to deliver the folder associated with rejection disposition and the folder associated with acceptance disposition, according to an embodiment;

FIG. 14 is a flowchart of a method of comparing a transmittal file to another file, according to an embodiment;

FIG. 15 is a flowchart of a method to exchange in a predetermined architecture of graphic document interchange, according to an embodiment;

FIG. 16 is a flowchart of a method of actions additional to FIG. 15 above, according to an embodiment;

FIG. 17 is a flowchart of a method to exchange form-fillable construction specification PDF(s), according to an embodiment;

FIG. 18 is a flowchart of a method to add job-specific information to the plurality of form-fillable construction specification PDF(s), according to an embodiment;

FIG. 19 is a flowchart of a method to modify a form-fillable construction specification PDF, according to an embodiment;

FIG. 20 is a flowchart of a method to aggregate a plurality of form-fillable construction specification PDF(s), according to an embodiment;

FIG. 21 is a flowchart of a method to determine the acceptance/rejection of each of the plurality of form-fillable construction specification PDF(s), according to an embodiment;

FIG. 22 is a flowchart of a method to associate the acceptance/rejection with the form-fillable construction specification PDF, according to an embodiment;

FIG. 23 is a flowchart of a method of delivery of accepted/rejected form-fillable construction specification PDFs, according to an embodiment;

FIG. 24 is a flowchart of a method of delivery of accepted/rejected form-fillable construction specification PDFs, according to an embodiment;

FIG. 25 is a flowchart of a method to deliver the folder associated with rejection and the folder associated with acceptance, according to an embodiment;

FIG. 26 is a flowchart of a method to deliver the folder associated with rejection and the folder associated with acceptance, according to an embodiment;

FIG. 27 is a flowchart of a method to deliver the folder associated with rejection and the folder associated with acceptance, according to an embodiment;

FIG. 28 is a flowchart of a method to compare a transmittal file to a file in the project folder according to an embodiment;

FIG. 29 is a flowchart of a method to exchange in a predetermined architecture of form-fillable construction specification PDF interchange, according to an embodiment;

FIG. 30 is a flowchart of a method of actions additional to FIG. 28 above, according to an embodiment;

FIG. 31 is a flowchart of a method to exchange form-fillable construction specification PDF(s), according to an embodiment;

FIG. 32 is a block diagram of a hardware and operating environment in which different embodiments can be practiced;

FIG. 33 is a block diagram of a system operable to manage construction information between the various actors of a construction project;

FIG. 34 is a block diagram of a main menu graphical user interface, according to an embodiment;

FIG. 35 is a block diagram of a project main menu graphical user interface, according to an embodiment;

FIG. 36 is a block diagram of an equipment schedule menu page graphical user interface, according to an embodiment;

FIG. 37 is a block diagram of an open schedule box graphical user interface, according to an embodiment;

FIG. 38 is a block diagram of a library menu page graphical user interface, according to an embodiment;

FIG. 39 is a block diagram of a document transmittal sheet library main page graphical user interface, according to an embodiment;

FIG. 40 is a block diagram of a document selection page graphical user interface graphical user interface, according to an embodiment;

FIG. 41 is a block diagram of a transmittal page graphical user interface, according to an embodiment;

FIG. 42 is a block diagram of additional notes transmittal graphical user interface, according to an embodiment; and

FIG. 43 is a block diagram of an assembler graphical user interface showing files ready to transmit, according to an embodiment.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The detailed description is divided into five sections. In the first section, a system level overview is described. In the second section, embodiments of methods are described. In the third section, a hardware and the operating environment in conjunction with which embodiments may be practiced are described. In the fourth section, particular implementations are described. Finally, in the fifth section, a conclusion of the detailed description is provided.

### System Level Overview

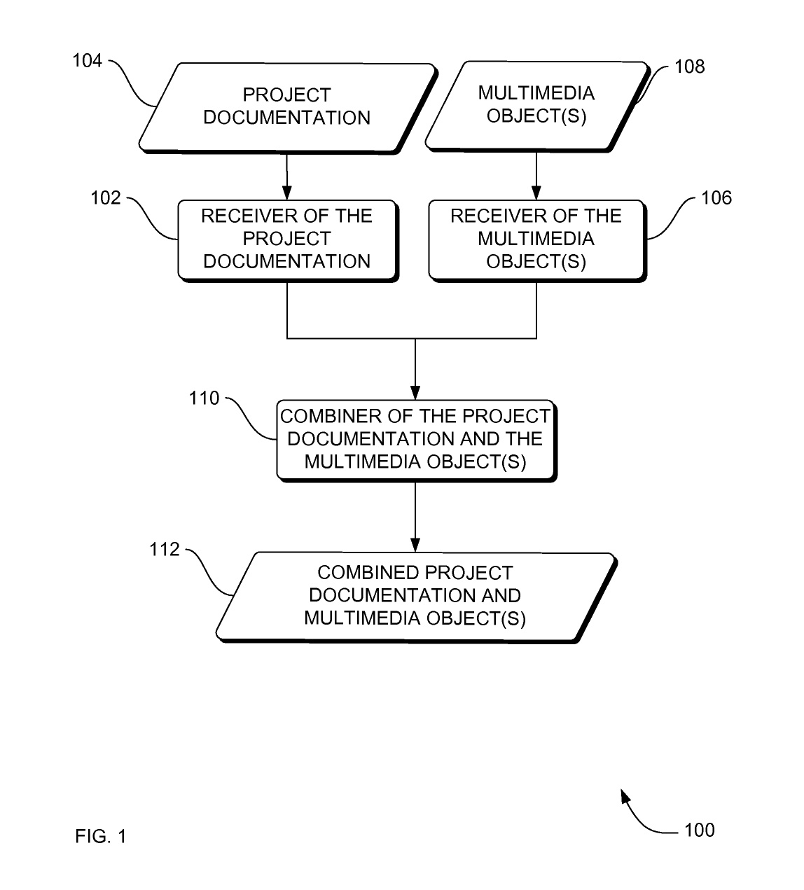

FIG. 1 is a block diagram of an overview of a system 100 to exchange project information in a predetermined architecture of multimedia object interchange. System 100 solves the need in the art to improve the organization and architecture of workflow of multimedia objects between heterogeneous computer systems.

System 100 includes a receiver 102 of project information 104 that is operable to store the project information 104 (e.g. project documentation) to a computer-accessible medium. In some embodiments, the project information 104 or project documentation includes construction project documentation.

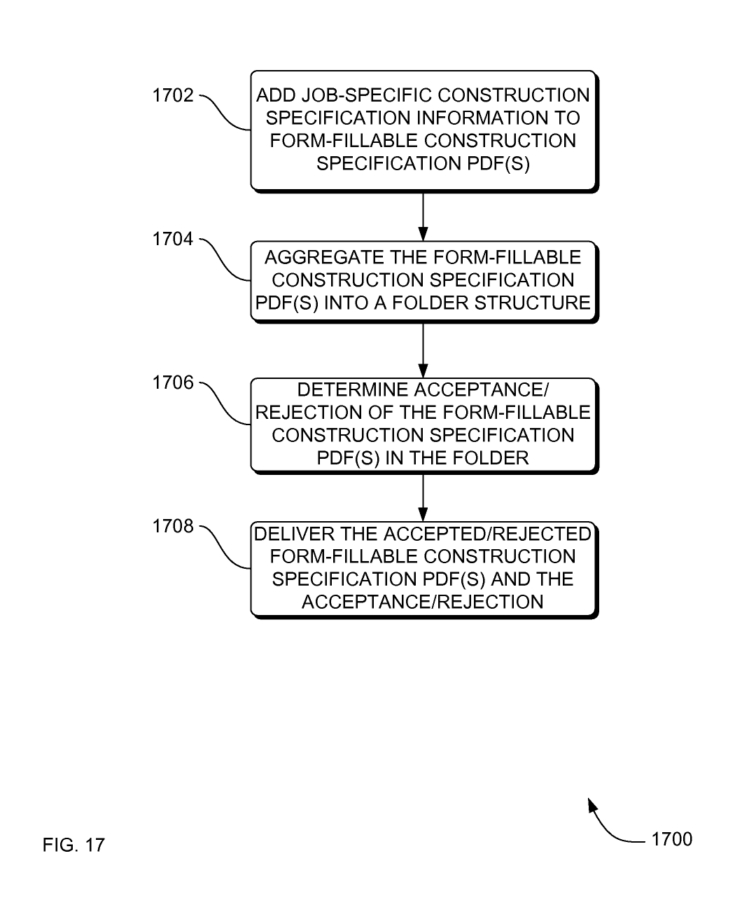

System 100 also includes a receiver 106 of one or more multimedia object(s) 108 that is operable to store the multimedia object(s) to computer-accessible medium. In some embodiments, the one or more multimedia object(s) 108 include a graphic document such as a portable document format (PDF) document or a form-fillable PDF document. PDF is described is greater detail below in conjunction with FIG. 17. A form fillable document is a document that has predefined fields specifically designed to accommodate data entry.

The receiver 102 and the receiver 106 can be operated in any order, such as simultaneously, or in sequential order in which receiver 106 is operated before receiver 102.

Thereafter, system 100 also includes a combiner 110 of the one or more multimedia object(s) 108 and the project information 104. Combined 112 multimedia object(s) and project information 104 provides for an encapsulation of the multimedia object(s) 108 and project information 104 that in turn results in an organization of the multimedia object(s) and project documentation organization that increases the ease and readiness at which the multimedia object(s) and project documentation can be integrated in systemic architecture of workflow of multimedia objects between heterogeneous computer systems.

While the system 100 is not limited to any particular receiver 102, project information 104, receiver 106, object(s) 108, combiner 110 and combined 112 multimedia object(s) and project information, for sake of clarity a simplified receiver 102, project information 104, receiver 106, object(s) 108, combiner 110 and combined 112 multimedia object(s) and project information are described.

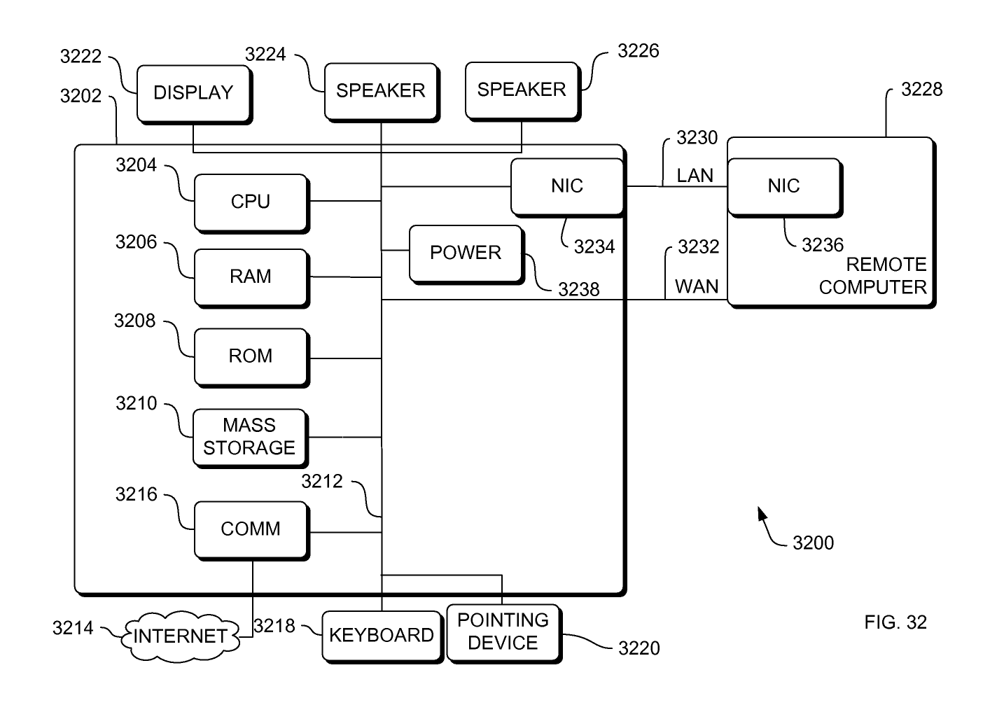

The system level overview of the operation of an embodiment is described above in this section of the detailed description. Some embodiments operate in a multi-processing, multi-threaded operating environment on a computer, such as computer 3202 in FIG. 32.

### Method Embodiments

In the previous section, a system level overview of the operation of an embodiment is described. In this section, the particular methods of such an embodiment are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 200-3100 are performed by a program executing on, or performed by firmware or hardware that is a part of, a computer, such as computer 3202 in FIG. 32.

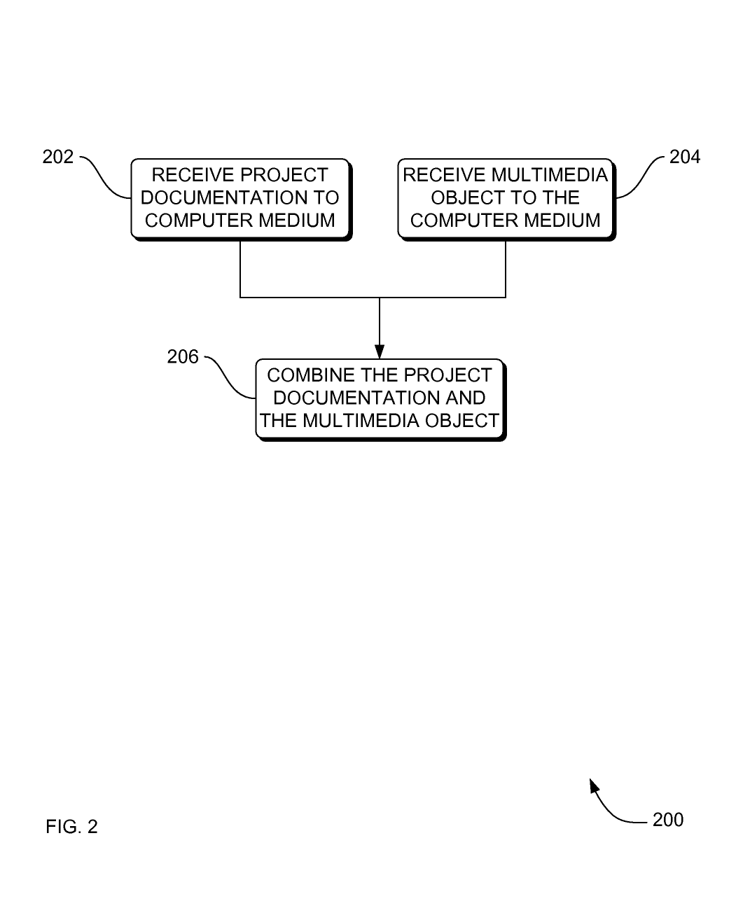

FIG. 2 is a block diagram of an overview of a method 200 to exchange project information in a predetermined architecture of multimedia object interchange. Method 200 solves the need in the art to improve the organization and architecture of workflow of multimedia objects between heterogeneous computer systems.

Method 200 includes receiving 202 project documentation to a computer-accessible medium. In one embodiment, the project documentation includes construction project documentation. In the example of the construction industry, the construction project documentation includes architecture drawings and material specifications maintenance and operation manuals, submittals, start up reports, commissioning reports, photographs, movies, executable programs.

Receiving 202 is one embodiment of the receiver 102 of project information 104 in FIG. 1.

Method 200 also includes receiving 204 one or more multimedia object(s) to the computer-accessible medium. Receiving 204 is one embodiment of the receiver 106 of the one or more multimedia object(s) 108. The receiving actions 202 and 204 can be performed in any order, such as simultaneously, or in sequential order in which action 204 is performed before action 202.

Thereafter, method 200 also includes combining 206 the one or more multimedia object(s) and the project documentation. The combined multimedia object(s) and project documentation provides for an encapsulation of the multimedia object(s) and project documentation that in turn results in an organization of the multimedia object(s) and project documentation organization that increases the ease and readiness at which the multimedia object(s) and project documentation can be integrated in a systemic architecture of workflow of multimedia objects between heterogeneous computer systems.

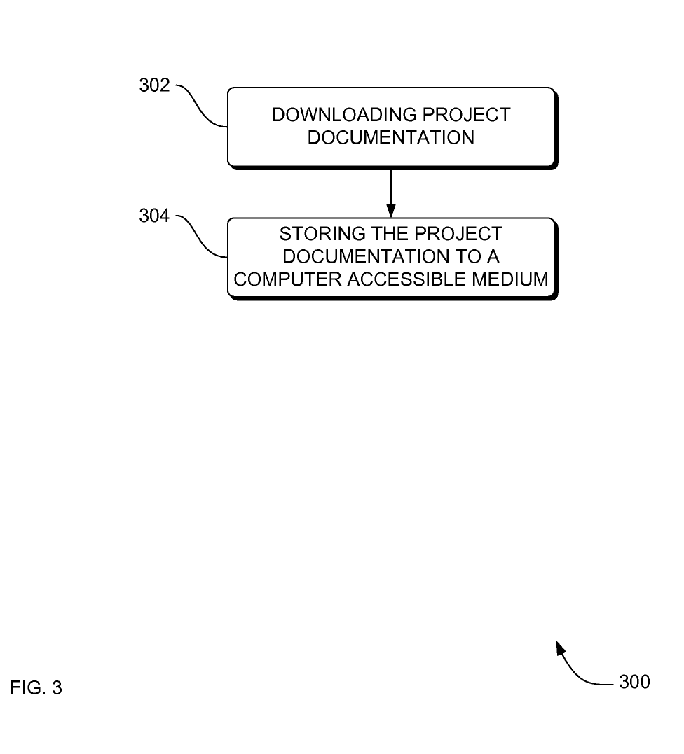

FIG. 3 is a flowchart of a method 300 of receiving project documentation, according to an embodiment. Method 300 solves the need in the art improve the organization and architecture of workflow of multimedia objects between heterogeneous computer systems.

In method 300, the action of receiving 202 project documentation of FIG. 2 includes downloading 302 the project documentation, such as from the Internet or other network, and the action of receiving the project documentation 202 includes storing 304 the project documentation to a computer accessible medium.

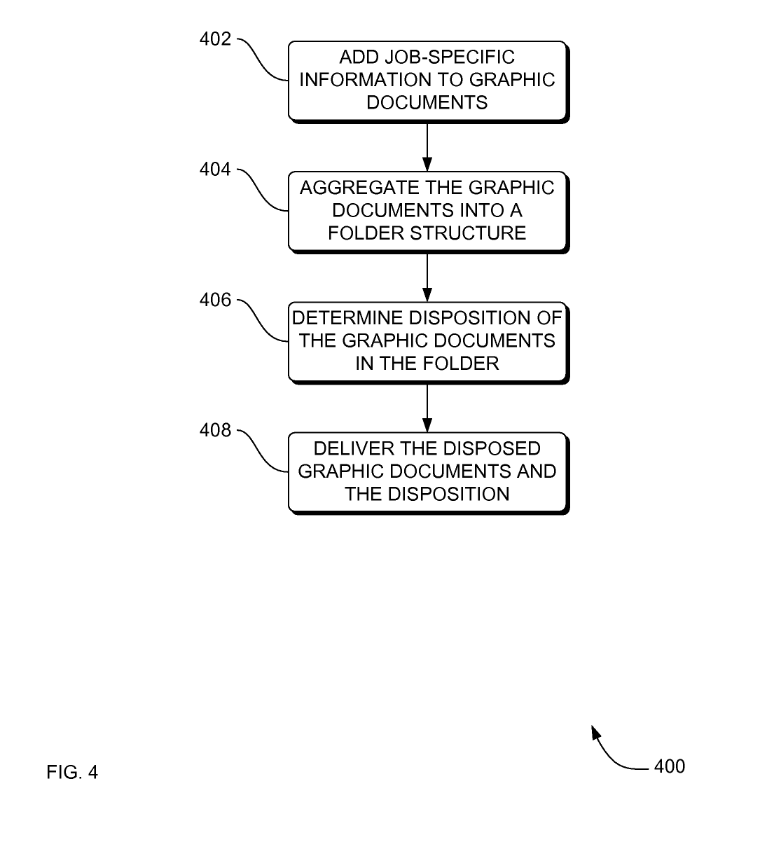

FIG. 4 is a flowchart of a method 400 to exchange graphic documents, according to an embodiment. Method 400 solves the need in the art to improve the organization and architecture of workflow of multimedia objects between heterogeneous computer systems.

Method 400 includes adding 402 job-specific information to a plurality of graphic documents. The plurality of graphic documents have a file name that is in accordance, conformance, and/or in reference to a standardized documentation nomenclature. The standardized documentation nomenclature is discussed in further detail below. The adding 402 is performed upon each of the plurality of graphic documents by a materials originator; wherein the plurality of graphic documents are added by a plurality of material originators.

Method 400 includes aggregating 404 the plurality of graphic documents into a folder data structure. The folder data structure is located on a computer-accessible medium. In some embodiments, the aggregating is performed by an aggregator, which can be a person or an inanimate object such as a computer. In the construction industry, the aggregator is a general contractor.

Method 400 also includes determining 406 a disposition of each of the plurality of graphic documents in reference to the job-specific information in each of the plurality of graphic documents.

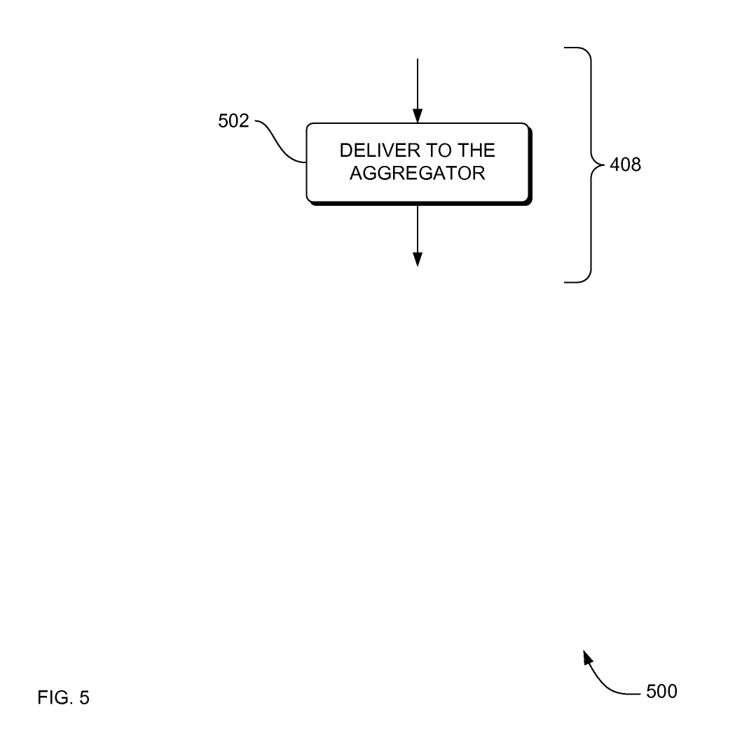

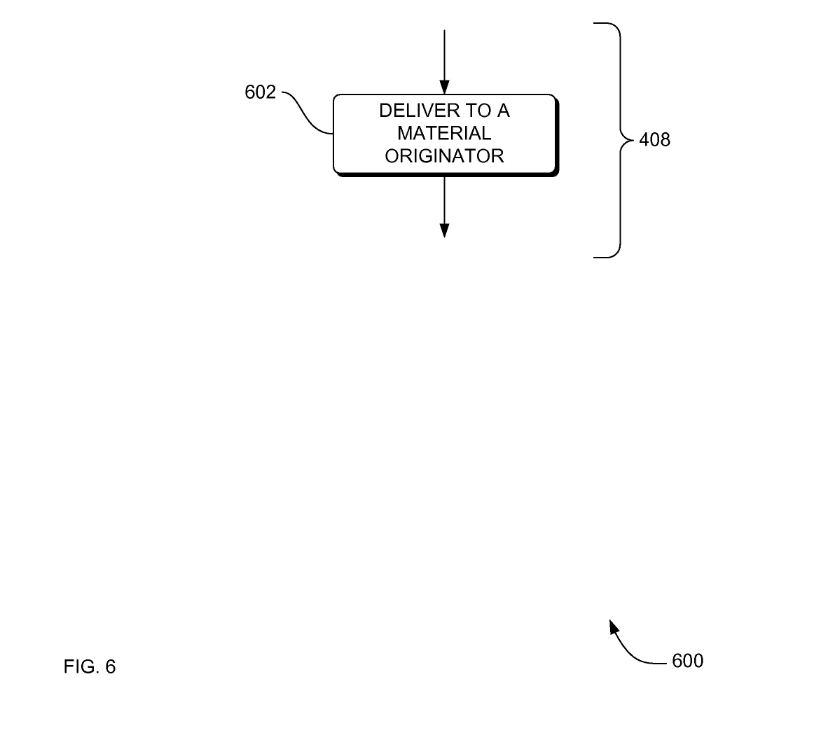

Method 400 also includes delivering 408 each of the disposed plurality of graphic documents and delivering the disposition of each of the disposed plurality of graphic documents. In some embodiments such as described in FIG. 5 below, the delivery is to the aggregator. In some embodiments such as described in FIG. 6 below, the delivery is to one of the plurality of material originators that added the job-specific information to the graphic document in action 402 above.

A variety of standardized documentation nomenclatures can be implemented, such as MasterFormat™, UniFormat™, SectionFormat™ and PageFormat™ that are published by the Construction Specification Institute of Alexandria, Va. In some embodiments, the standardized documentation nomenclature is an organizational structure for specifying using prescriptive-based (descriptive, proprietary, and reference standard) construction specifications. In some embodiments, the standardized documentation nomenclature is an organizational structure for performance based construction specifications and construction specifications that combine both the prescriptive and performance modes of specifying. In some embodiments, the standardized documentation nomenclature is an organizational structure for procurement specifying. In some embodiments, the standardized documentation nomenclature is an organizational structure for detailed cost analysis.

In some embodiments, the standardized documentation nomenclature is an accepted classification system for Construction Systems and Assemblies, cost models, facility management based upon “function” (e.g., foundations provide the function to stabilize and support). In some embodiments, the standardized documentation nomenclature is an accepted organizational system for preliminary project descriptions, performance based construction specifications and project manuals when design-build project delivery is employed. In some embodiments, the standardized documentation nomenclature is in conformance to generally accepted method of filing drawings, such as the Uniform Drawing System of the U.S. National CAD Standard.

In some embodiments, the standardized documentation nomenclature is in conformance with a three-part format for writing construction specifications (e.g. general, products, and execution). In some embodiments, the standardized documentation nomenclature is the general portion of the format that provides listing of administrative and procedural requirements specific to the section. In some embodiments, the products section of the format provides a listing of requirements for products, and fabrication prior to incorporation into a project. In some embodiments, the execution portion of the format provides a listing of requirements for on-site work activity. In some embodiments, the requirements listing includes schedules. In some embodiments, the three-part format groups administrative, product requirements and execution requirements under each product separately. In some embodiments, the standardized documentation nomenclature is provides a uniform approach to organizing specification text within each section. In some embodiments, the standardized documentation nomenclature is based upon the principle that a section should be organized by grouping the administrative requirements, product requirements, and execution requirements for each product together.

In some embodiments, the standardized documentation nomenclature is in conformance with and use of levels and alignment. In some embodiments, the levels include a first level. In some embodiments the first level is an article heading with no specified requirements. In some embodiments, the levels include a second level. In some embodiments the second level is paragraph that is a specified requirement, or heading if followed by subparagraphs or other subsequent levels. In some embodiments, the levels include a third level. In some embodiments the third level is a first subparagraph. In some embodiments, the levels include a fourth level. In some embodiments the fourth level is a second subparagraph. In some embodiments, the levels include a fifth level. In some embodiments the fifth level is third subparagraph. In some embodiments, lower level requirements apply to higher level requirements.

FIG. 5 is a flowchart of a method 500 to deliver disposed graphic documents and the disposition of the graphic documents, according to an embodiment. Method 500 is one embodiment of delivering 408 in FIG. 4 above. Method 500 solves the need in the art to improve the organization and architecture of workflow of multimedia objects between heterogeneous computer systems.

Method 500 includes delivering 502 each of the disposed plurality of graphic documents and the disposition of each of the disposed plurality of graphic documents to the aggregator.

FIG. 6 is a flowchart of a method 600 to deliver disposed graphic documents and the disposition of the graphic documents, according to an embodiment. Method 600 is one embodiment of delivering 408 in FIG. 4 above. Method 600 solves the need in the art to improve the organization and architecture of workflow of multimedia objects between heterogeneous computer systems.

Method 600 includes delivering 602 each of the disposed plurality of graphic documents and the disposition of each of the disposed plurality of graphic documents to one or more of the material originators, such as the materials originator that that added the job-specific information to the graphic document in action 402 above.

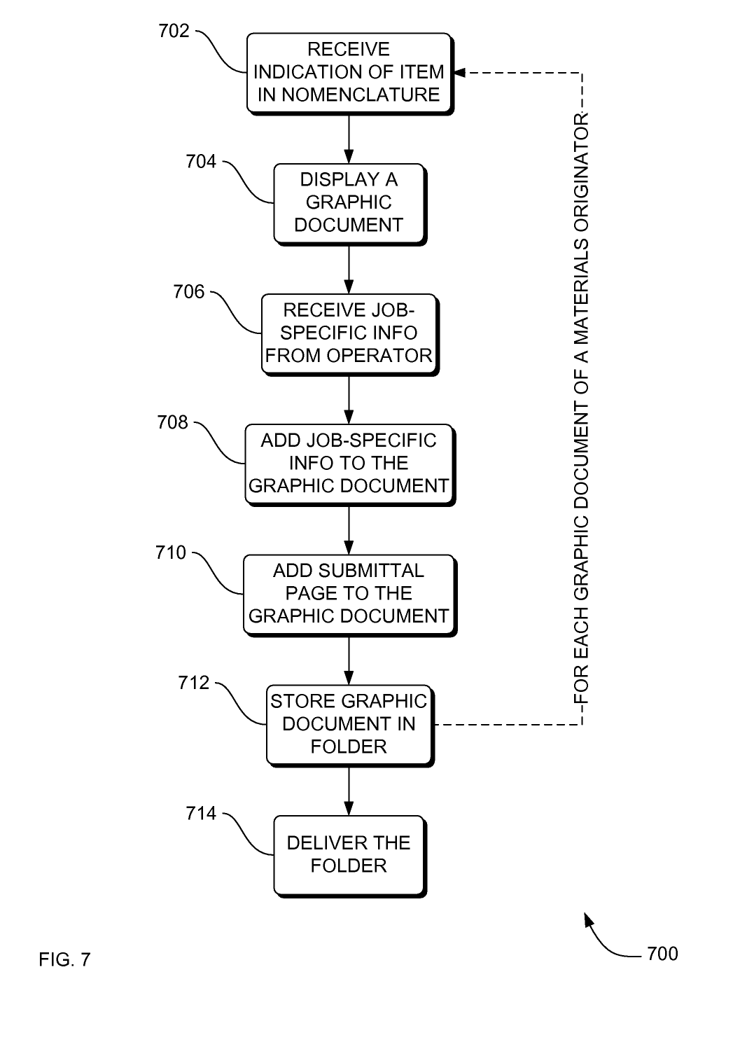

FIG. 7 is a flowchart of a method 700 to add job-specific information to the plurality of graphic documents, according to an embodiment. Method 700 is one embodiment of adding 402 job-specific information to the plurality of graphic documents. Method 700 solves the need in the art to improve the organization and architecture of workflow of multimedia objects between heterogeneous computer systems.

Some embodiments of method 700 include receiving 702 an indication from an operator of a computer of an item in the standardized documentation nomenclature. The indication includes an HTTP request that is invoked from a graphic user interface label indicating the name of the item in the standardized documentation nomenclature.

Some embodiments of method 700 include displaying 704 a graphic document of the item.

Some embodiments of method 700 include receiving 706 the job-specific information from the operator.

Some embodiments of method 700 include modifying 708 the graphic document by addition of the job-specific information of the job-specific information to the graphic document.

Some embodiments of method 700 include adding 710 a submittal page to the graphic document.

Some embodiments of method 700 include storing 712 the graphic document in the folder data structure on the computer-accessible medium with the file name in accordance with the item in the standardized documentation nomenclature.

Method 700 repeats each of the above actions in FIG. 7 for each of the graphic documents of a materials originator. Thereafter, method 700 includes delivering 714 the folder of the graphic documents.

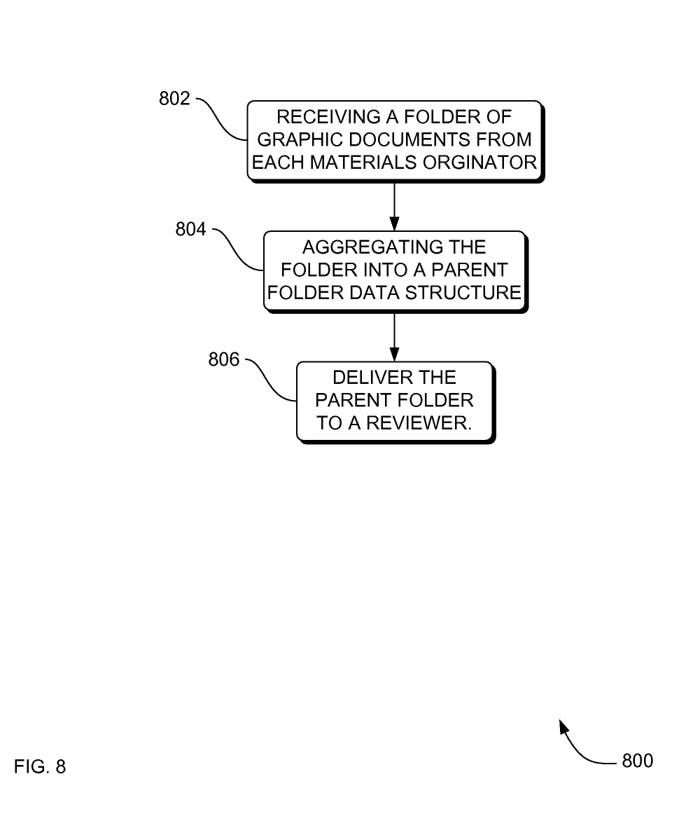

FIG. 8 is a flowchart of a method 800 to aggregate a plurality of graphic documents, according to an embodiment. Method 800 is one embodiment of aggregating a plurality of graphic documents. Method 800 solves the need in the art to improve the organization and architecture of workflow of multimedia objects between heterogeneous computer systems.

Some embodiments of method 800 include receiving 802 at least one folder of graphic documents from each of the plurality of materials originators 802

Some embodiments of method 800 include aggregating 804 the folders into a project (or parent) folder data structure. The project folder data structure is on a computer-accessible medium. The aggregating is performed by the aggregator.

Some embodiments of method 800 include delivering 806 the parent folder of the graphic documents to a professional reviewer.

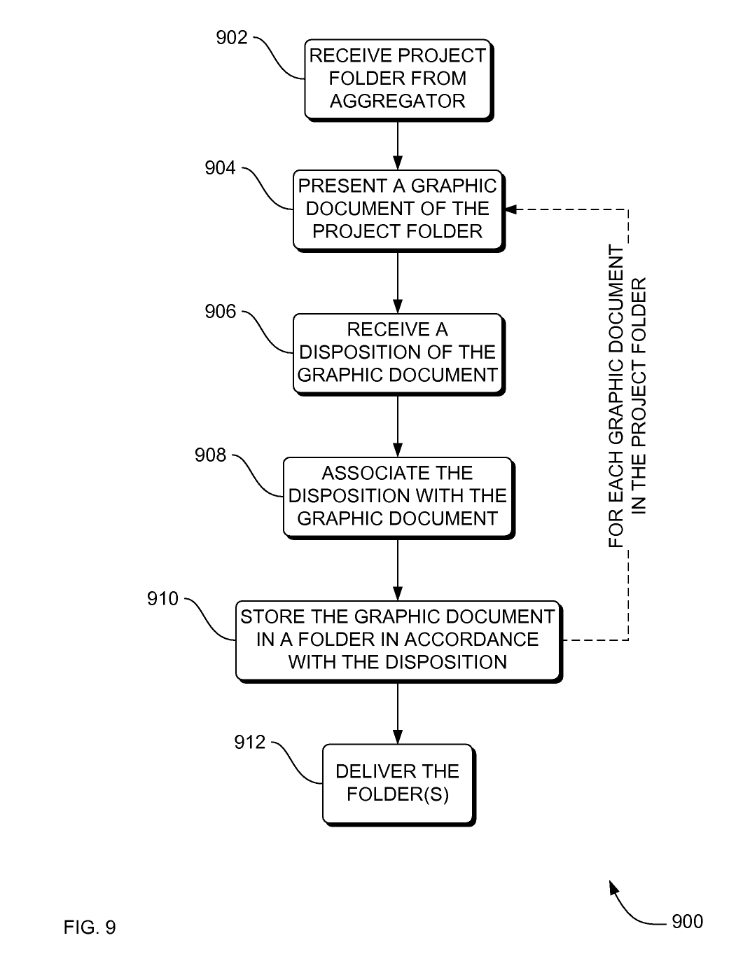

FIG. 9 is a flowchart of a method 900 to direct the processor to determine the disposition of each of the plurality of graphic documents, according to an embodiment. Method 900 is one embodiment of directing 404 the processor to determine the disposition of each of the plurality of graphic documents in FIG. 4 above. Method 900 solves the need in the art to improve the organization and architecture of workflow of multimedia objects between heterogeneous computer systems.

Some embodiments of method 900 include receiving 902 a project folder from the aggregator.

Method 900 includes the remaining actions of method 900 that are performed once for each graphic document in the project folder.

Some embodiments of method 900 include presenting 904 the graphic document to a professional reviewer.

Some embodiments of method 900 include receiving 906 a disposition of the graphic document.

Some embodiments of method 900 include associating 908 the disposition with the graphic document.

Some embodiments of method 900 include storing 910 the graphic document in a folder associated with rejection disposition or saving the graphic document in a folder associated with acceptance disposition depending on the disposition.

Some embodiments of method 900 include delivering 912 the folder associated with rejection disposition and the folder associated with acceptance disposition.

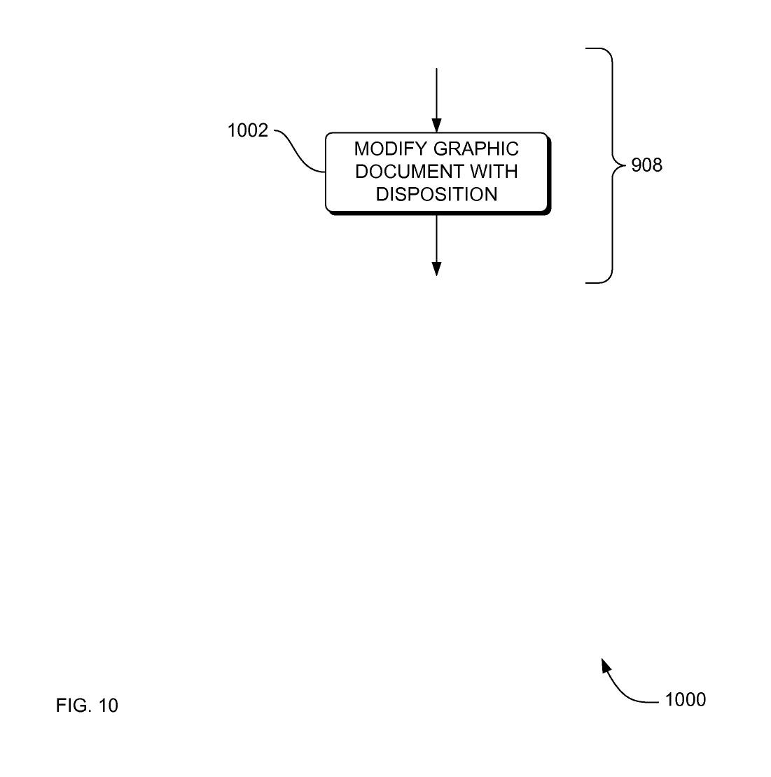

FIG. 10 is a flowchart of a method 1000 to associate the disposition with the graphic document, according to an embodiment. Method 1000 is one embodiment of to associating 908 the disposition with the graphic document in FIG. 9 above. Method 1000 solves the need in the art to improve the organization and architecture of workflow of multimedia objects between heterogeneous computer systems.

Method 1000 includes modifying 1002 the graphic document with the disposition.

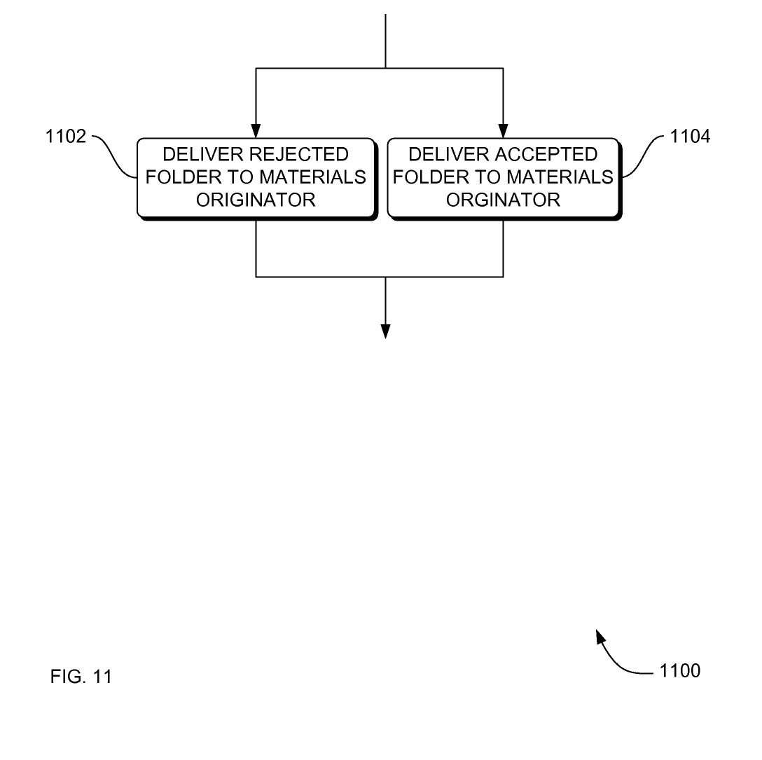

FIG. 11 is a flowchart of a method 1100 to deliver the folder associated with rejection disposition and the folder associated with acceptance disposition, according to an embodiment. Method 1100 is one embodiment of delivering 912 the folder associated with rejection disposition and the folder associated with acceptance disposition in FIG. 9 above. Method 1100 solves the need in the art to improve the organization and architecture of workflow of multimedia objects between heterogeneous computer systems.

Method 1100 includes delivering 1102 to a material originator the folder associated with rejection disposition and delivering 1104 to the materials originator the folder associated with acceptance disposition.

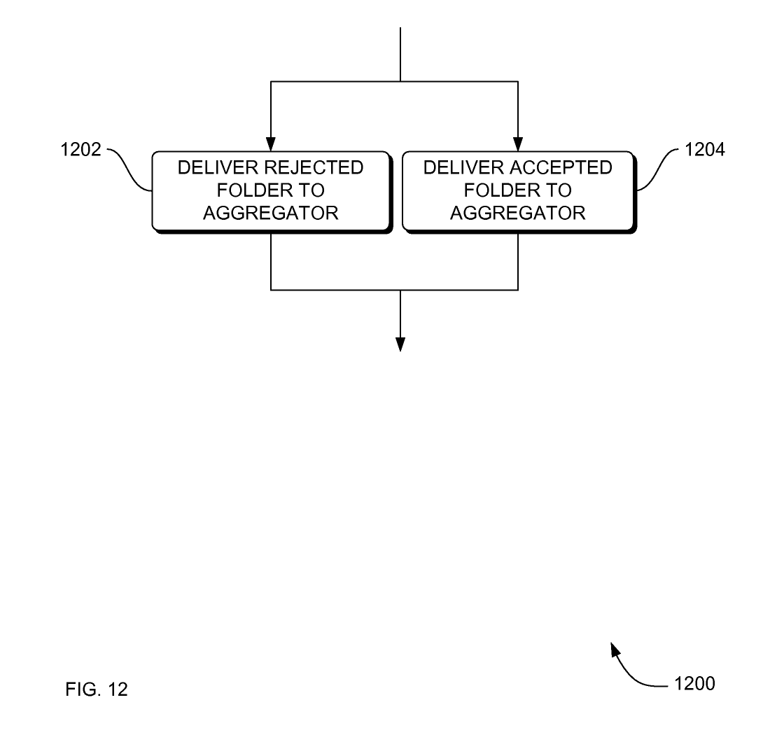

FIG. 12 is a flowchart of a method 1200 to deliver the folder associated with rejection disposition and the folder associated with acceptance disposition, according to an embodiment. Method 1200 is one embodiment of delivering 912 the folder associated with rejection disposition and the folder associated with acceptance disposition in FIG. 9 above. Method 1200 solves the need in the art to improve the organization and architecture of workflow of multimedia objects between heterogeneous computer systems.

Method 1200 includes delivering 1202 to an aggregator the folder associated with rejection disposition and delivering 1204 to the aggregator the folder associated with acceptance disposition.

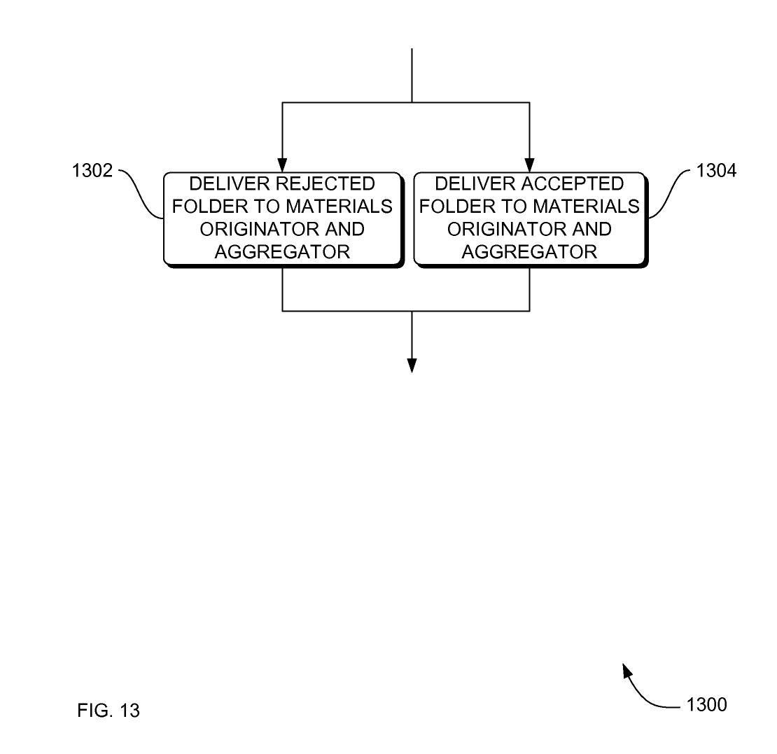

FIG. 13 is a flowchart of a method 1300 to deliver the folder associated with rejection disposition and the folder associated with acceptance disposition, according to an embodiment. Method 1300 is one embodiment of delivering 913 the folder associated with rejection disposition and the folder associated with acceptance disposition in FIG. 9 above. Method 1300 solves the need in the art to improve the organization and architecture of workflow of multimedia objects between heterogeneous computer systems.

Method 1300 includes delivering 1302 to an aggregator and to the materials originator the folder associated with rejection disposition and delivering 1304 to the aggregator and to the materials originator the folder associated with acceptance disposition.

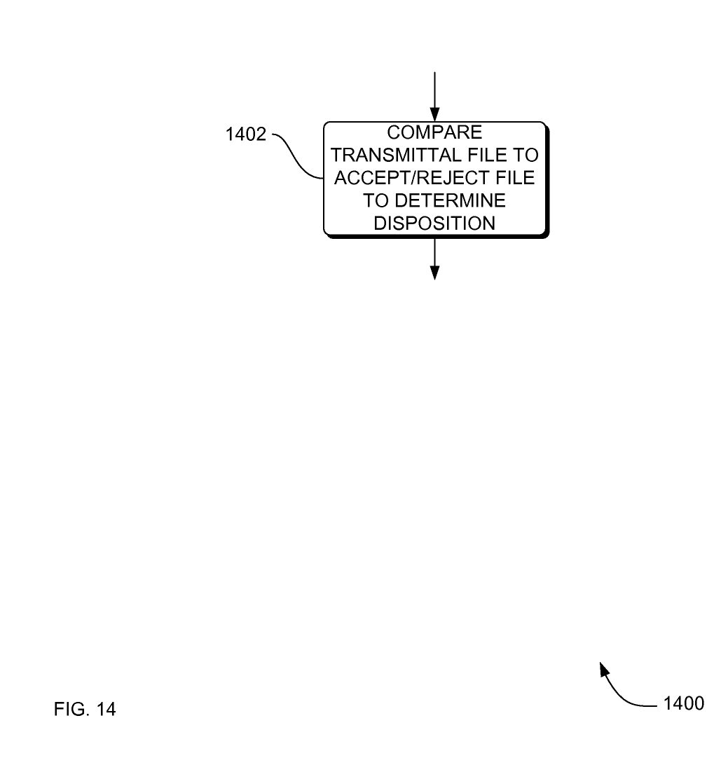

FIG. 14 is a flowchart of a method 1400 of comparing a transmittal file to another file, according to an embodiment. Method 1400 solves the need in the art to improve the organization and architecture of workflow of multimedia objects between heterogeneous computer systems.

Some embodiments of method 1400 include comparing 1402 a transmittal file to a file in the reject/accept folder of the project folder. The comparison 1402 indicates the disposition of the transmittal file.

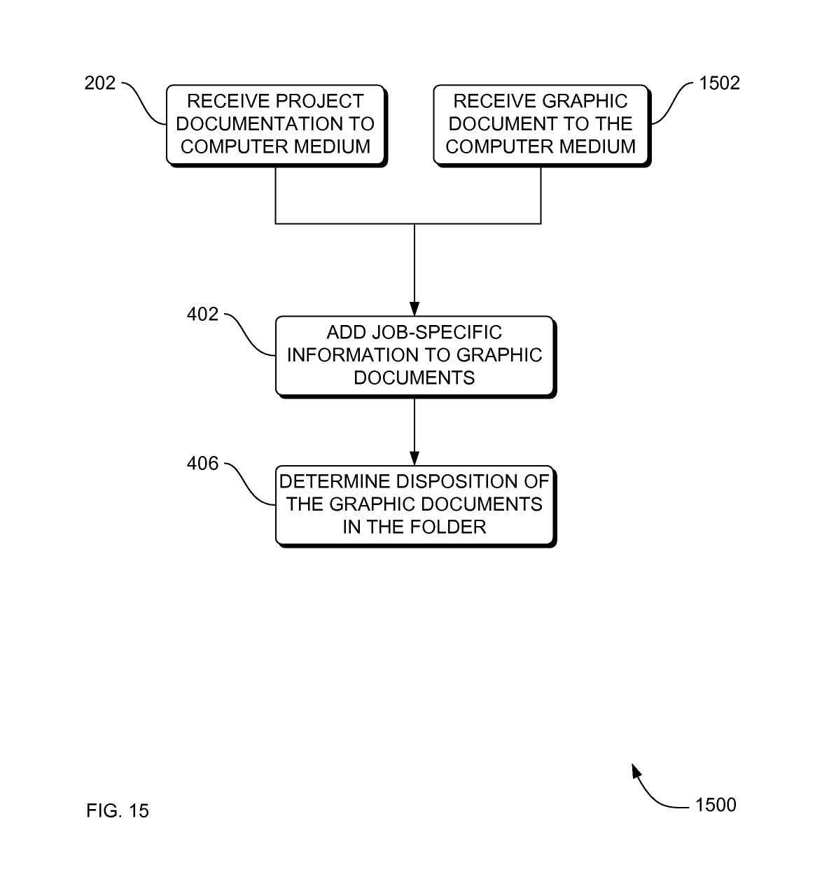

FIG. 15 is a flowchart of a method 1500 to exchange in a predetermined architecture of graphic document interchange, according to an embodiment. Method 1500 solves the need in the art to improve the organization and architecture of workflow of multimedia objects between heterogeneous computer systems.

Some embodiments of method 1500 include receiving 202 project documentation to a computer-accessible medium. In some embodiments, the project documentation includes construction project documentation. Receiving 202 is one embodiment of the receiver 102 of project information 104 in FIG. 1.

Method 200 also includes receiving 1502 one or more graphic document(s) to the computer-accessible medium. Receiving 1502 is one embodiment of the receiver 106 of the one or more graphic document(s) 108. The receiving actions 202 and 1502 can be performed in any order, such as simultaneously, or in sequential order in which action 1502 is performed before action 202.

Some embodiments of method 1500 include adding 402 job-specific information to a plurality of graphic documents. The plurality of graphic documents have a file name that is in accordance, conformance, and/or in reference to a standardized documentation nomenclature. The standardized documentation nomenclature is discussed in further detail below. The adding 402 is performed upon each of the plurality of graphic documents by a materials originator; wherein the plurality of graphic documents are added by a plurality of material originators.

Some embodiments of method 1500 include determining 406 a disposition of each of the plurality of graphic documents in reference to the job-specific information in each of the plurality of graphic documents.

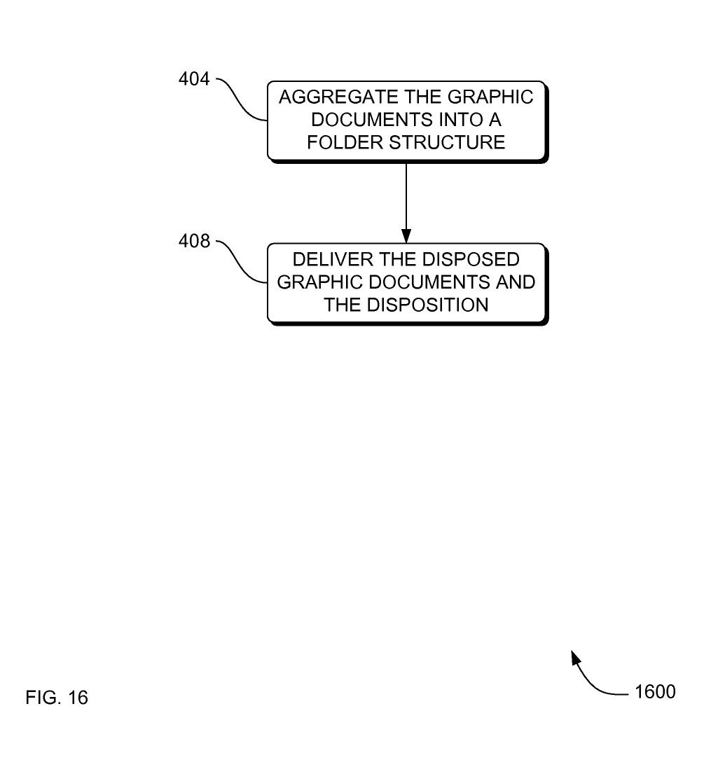

FIG. 16 is a flowchart of a method 1600 of actions additional to method 1500 in FIG. 15 above, according to an embodiment. Method 1600 solves the need in the art to improve the organization and architecture of workflow of multimedia objects between heterogeneous computer systems.

Some embodiments of method 1600 include aggregating 404 the plurality of graphic documents into a folder data structure. The folder data structure is located on a computer-accessible medium. In some embodiments, the aggregating is performed by an aggregator, which can be a person or an inanimate object such as a computer.

Method 1600 also includes delivering 408 each of the disposed plurality of graphic documents and delivering the disposition of each of the disposed plurality of graphic documents. In some embodiments such as described in FIG. 5 above, the delivery is to the aggregator. In some embodiments such as described in FIG. 6 above, the delivery is to one of the plurality of material originators that added the job-specific information to the graphic document in action 402 above.

FIG. 17 is a flowchart of a method 1700 to exchange form-fillable construction specification PDF(s), according to an embodiment. Method 1700 solves the need in the art to improve the organization and architecture of workflow of multimedia construction specific documents between heterogeneous computer systems in the construction industry.

Method 1700 includes adding 1702 job-specific construction specification information to a plurality of form-fillable construction specification PDF(s). The plurality of form-fillable construction specification PDF(s) have a file name that is in accordance, conformance, and/or in reference to a construction specification document nomenclature. The construction specification document nomenclature is discussed in further detail below. The adding 1702 is performed upon each of the plurality of form-fillable construction specification PDF(s) by a construction sub-contractor; wherein the plurality of form-fillable construction specification PDF(s) are added by a plurality of sub-contractors. A form-fillable PDF document is a PDF document that has predefined fields specifically designed to receive and store data entered in the field. The data entered into the fields are saved when the PDF document is saved.

The Portable Document Format (PDF) is an open file format created and controlled by Adobe Systems, for representing two-dimensional documents in a device independent and resolution independent fixed-layout document format. Each PDF file encapsulates a complete description of a 2D document (and, with the advent of Acrobat 3D, embedded 3D documents) that includes the text, fonts, images, and 2D vector graphics that compose the document. PDF files do not encode information that is specific to the application software, hardware, or operating system used to create or view the document. This feature ensures that a valid PDF will render exactly the same regardless of its origin or destination (but depending on font availability).

Anyone can create applications that read and write PDF files without having to pay royalties to Adobe Systems; Adobe holds a number of patents relating to the PDF format but licenses them on a royalty-free basis for use in developing software that complies with its PDF specification. PDF files are most appropriately used to encode the exact look of a document in a device-independent way. While the PDF format can describe very simple one page documents, the PDF format can also be used for many pages, complex documents that use a variety of different fonts, graphics, colors, and images.

Readers for many platforms are available, such as Xpdf, Foxit and Adobe's own Adobe Reader; there are also front-ends for many platforms to Ghostscript. PDF readers are generally free. There are many software options for creating PDFs, including the PDF printing capability built in to Mac OS X, the multi-platform OpenOffice, numerous PDF print drivers for Microsoft Windows, and Adobe Acrobat itself. Specialized software is also available for editing PDF files.

Method 1700 includes aggregating 1704 the plurality of form-fillable construction specification PDF(s) into a folder data structure. The folder data structure is located on a computer-accessible medium. In some embodiments, the aggregating is performed by a general contractor.

Method 1700 also includes determining 1706 acceptance or rejection of each of the plurality of form-fillable construction specification PDF(s) in reference to the job-specific information in each of the plurality of form-fillable construction specification PDF(s).

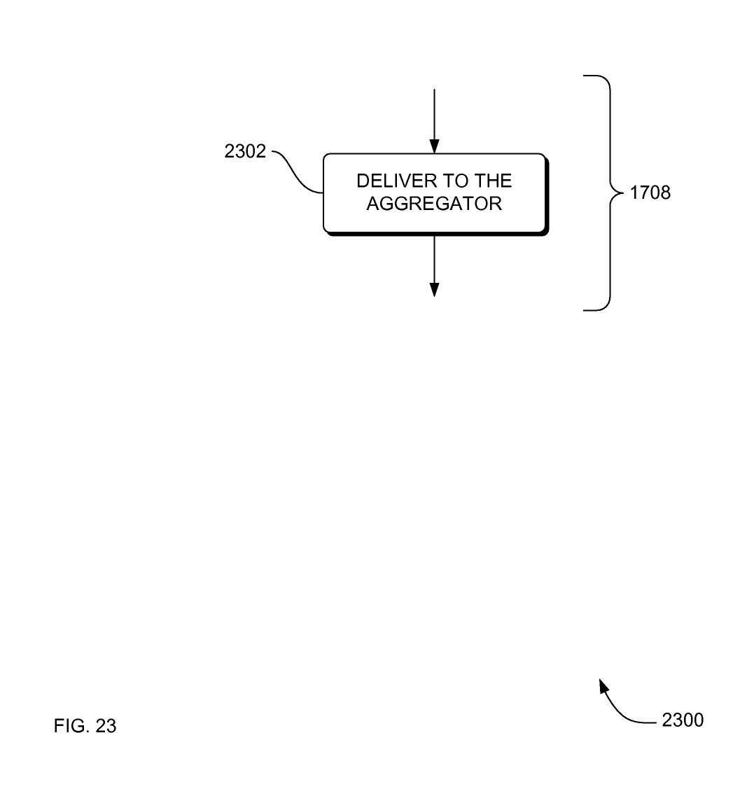

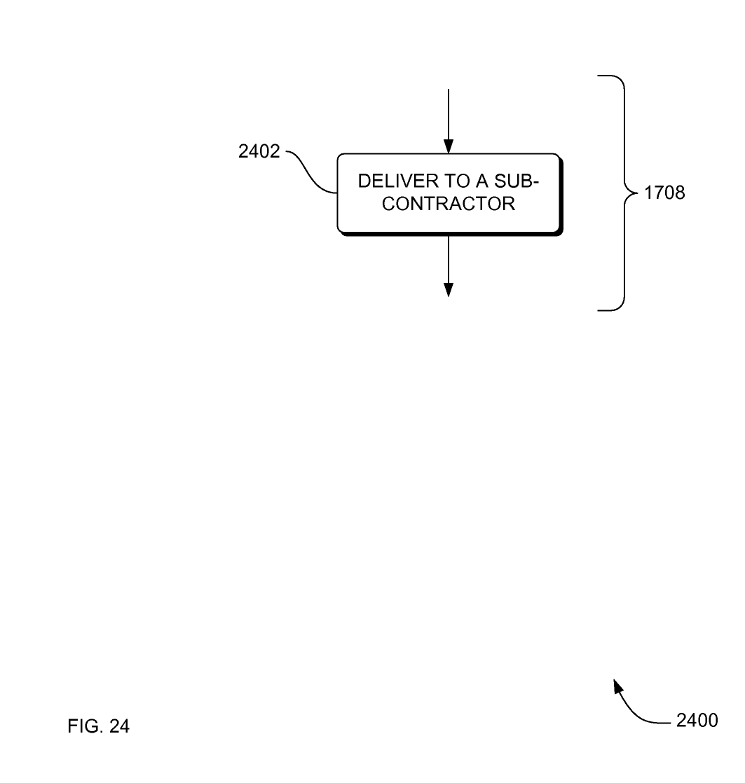

Method 1700 also includes delivering 1708 each of the accepted/rejected form-fillable construction specification PDF(s) and delivering the acceptance/rejection of each of the accepted/rejected form-fillable construction specification PDF(s). In some embodiments such as described in FIG. 23 below, the delivery is to the general contractor. In some embodiments such as described in FIG. 24 below, the delivery is to one of the plurality of sub-contractors that added the job-specific information to the form-fillable construction specification PDF in action 1702 above.

A variety of construction specification document nomenclatures can be implemented, such as MasterFormat™, UniFormat™, SectionFormat™ and PageFormat™ that are published by the Construction Specification Institute of Alexandria, Va. In some embodiments, the construction specification document nomenclature is an organizational structure for specification using prescriptive-based (descriptive, proprietary, and reference standard) construction specifications. In some embodiments, the construction specification document nomenclature is an organizational structure for performance based construction specifications and construction specifications that combine both the prescriptive and performance modes of specifying. In some embodiments, the construction specification document nomenclature is an organizational structure for procurement specifying. In some embodiments, the construction specification document nomenclature is an organizational structure for detailed cost analysis.

One example of a construction specification document nomenclature is an accepted classification system for Construction Systems and Assemblies, cost models, facility management based upon “function” (e.g., foundations provide the function to stabilize and support). In some embodiments, the construction specification document nomenclature is an accepted organizational system for preliminary project descriptions, performance based construction specifications and project manuals when design-build project delivery is employed. In some embodiments, the construction specification document nomenclature is in conformance to generally accepted method of filing drawings, such as the Uniform Drawing System of the U.S. National CAD Standard.

In some embodiments, the construction specification document nomenclature is in conformance with a three-part format for writing construction specifications (e.g. general, products, and execution). In some embodiments, the construction specification document nomenclature is the general portion of the format that provides listing of administrative and procedural requirements specific to the section. In some embodiments, the products section of the format provides a listing of requirements for products, and fabrication prior to incorporation into a project. In some embodiments, the execution portion of the format provides a listing of requirements for on-site work activity. In some embodiments, the requirements listing includes schedules. In some embodiments, the three-part format groups administrative, product requirements and execution requirements under each product separately. In some embodiments, the construction specification document nomenclature is provides a uniform approach to organizing specification text within each section. In some embodiments, the construction specification document nomenclature is based upon the principle that a section should be organized by grouping the administrative requirements, product requirements, and execution requirements for each product together.

In some embodiments, the construction specification document nomenclature is in conformance with and use of levels and alignment. In some embodiments, the levels include a first level. In some embodiments the first level is an article heading with no specified requirements. In some embodiments, the levels include a second level. In some embodiments the second level is paragraph that is a specified requirement, or heading if followed by subparagraphs or other subsequent levels. In some embodiments, the levels include a third level. In some embodiments the third level is a first subparagraph. In some embodiments, the levels include a fourth level. In some embodiments the fourth level is a second subparagraph. In some embodiments, the levels include a fifth level. In some embodiments the fifth level is third subparagraph. In some embodiments, lower level requirements apply to higher level requirements.

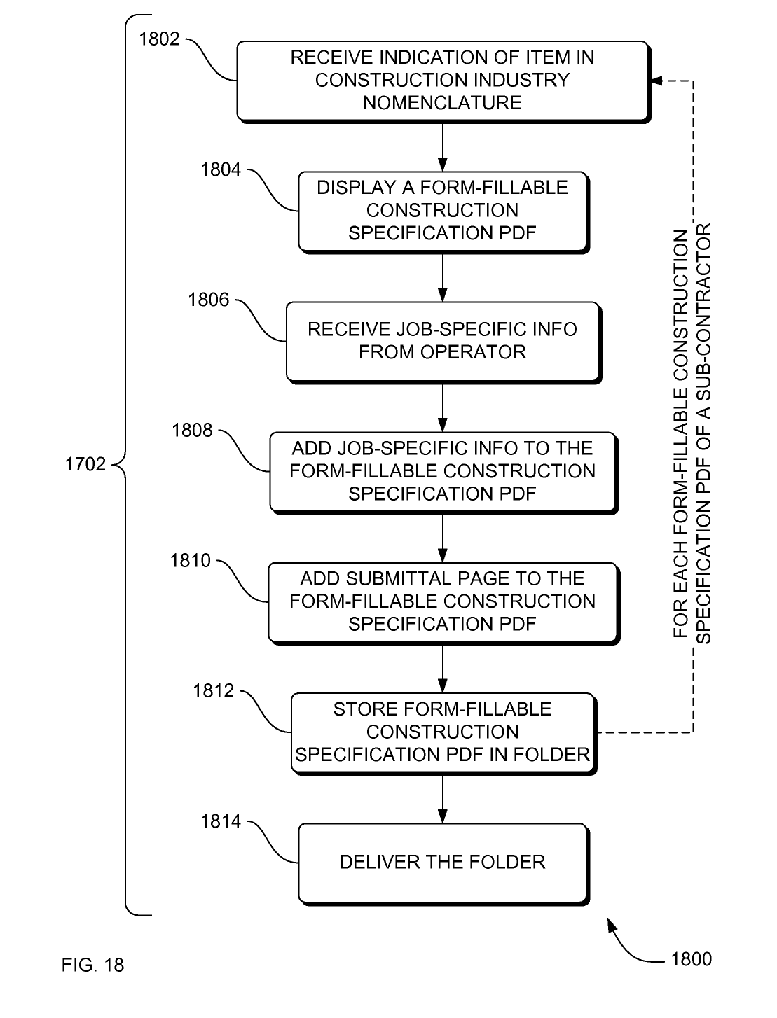

FIG. 18 is a flowchart of a method 1800 to add job-specific information to the plurality of form-fillable construction specification PDF(s), according to an embodiment. Method 1800 is one embodiment of adding 1702 job-specific information to the plurality of form-fillable construction specification PDF(s). Method 2000 solves the need in the art to improve the organization and architecture of workflow of multimedia objects between heterogeneous computer systems.

Some embodiments of method 1800 include receiving 1802 an indication from an operator of a computer of an item in the construction specification document nomenclature. The indication includes an HTTP request that is invoked from a graphic user interface label indicating the name of the item in the construction specification document nomenclature.

Some embodiments of method 1800 include displaying 1804 a form-fillable construction specification PDF of the item.

Some embodiments of method 1800 include receiving 1806 the job-specific information from the operator.

Some embodiments of method 1800 include modifying 1808 the form-fillable construction specification PDF by addition of the job-specific information of the job-specific information to the form-fillable construction specification PDF.

Some embodiments of method 1800 include adding 1810 a submittal page to the form-fillable construction specification PDF.

Some embodiments of method 1800 include storing 1812 the form-fillable construction specification PDF in the folder data structure on the computer-accessible medium with the file name in accordance with the item in the construction specification document nomenclature.

Method 1800 repeats each of the above actions in FIG. 18 for each of the form-fillable construction specification PDF(s) of a sub-contractor. Thereafter, method 1800 includes delivering 1814 the folder of the form-fillable construction specification PDF(s).

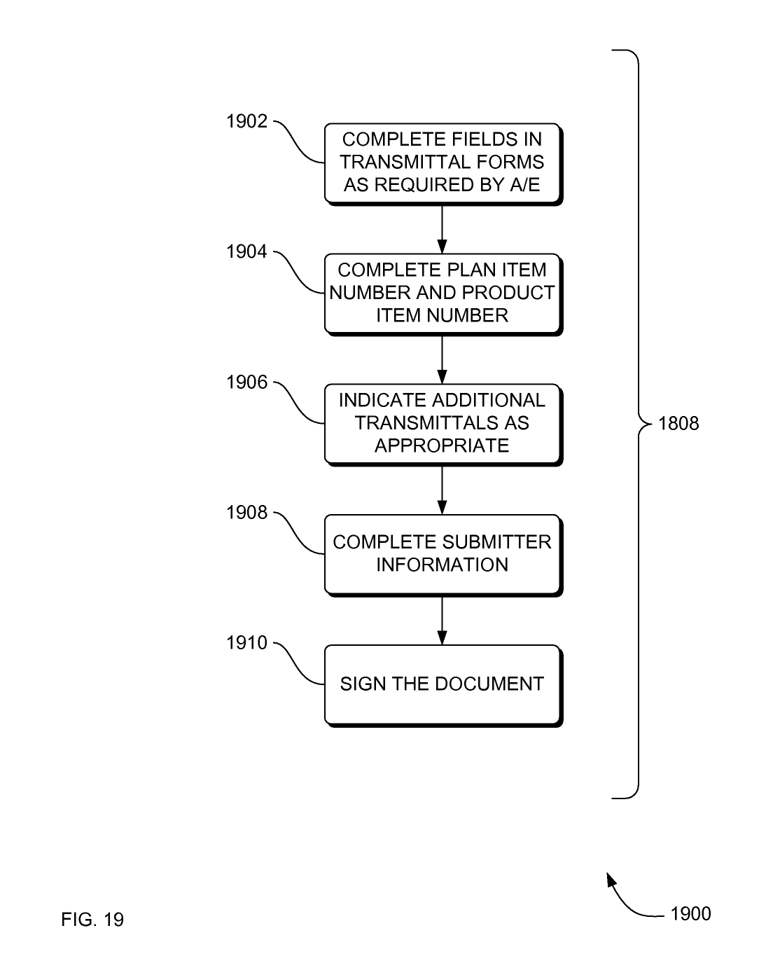

FIG. 19 is a flowchart of a method 1900 to modify a form-fillable construction specification PDF, according to an embodiment. Method 2000 is one embodiment of modifying 1808 the form-fillable construction specification PDF in FIG. 18 above. Method 1900 solves the need in the art to improve the organization and architecture of workflow of multimedia objects between heterogeneous computer systems.

Some embodiments of method 1900 include completing 1902 fields in a PDF transmittal form as required by an architect/engineer of the construction project. For example, action 1902 includes filling out fields in the transmittal for that describe or represent the transmittal form Project, To, Re:, Submittal Request Number, From, Date, A/E Project Number and Contract For as required by an architect or an engineer. The submittal request number is the number of the submittal for this section, the submittal request number is comprised of section number in CSI format with the end modifier of -1, R-1 (Resubmitted of Submittal #1), -2 etc. The CSI format is published by the Construction Specification Institute of Alexandria, Va.

Some embodiments of method 1900 include completing 1904 a Plan Item Number which is the marking of the item of the PDF transmittal form, and/or completing the Product Item which is the model number of the product of the PDF transmittal form. Some embodiments of method 1900 include completing field(s) in the PDF transmittal form that represent where the item is found in the Details, Schedules and Plan Locations Sections.

Some embodiments of method 1900 include completing 1906 fields in the PDF transmittal form that represent or indicate any additional transmittals in the additional transmittals section. For example of additional transmittal are transmittals that are not found elsewhere in the specifications for not attachable to a PDF document.

Some embodiments of method 1900 include completing 1908 fields in the PDF transmittal form that represent or indicate the submitter of the PDF transmittal form, such as Name, Address, Phone Number, email and fax number, and other notes in the submitter notes.

Some embodiments of method 1900 include completing 1910 fields in the PDF transmittal form that represent or indicate a signature of the submitter of the PDF transmittal form. In some embodiments, the signature is in a submitter section of the PDF transmittal form.

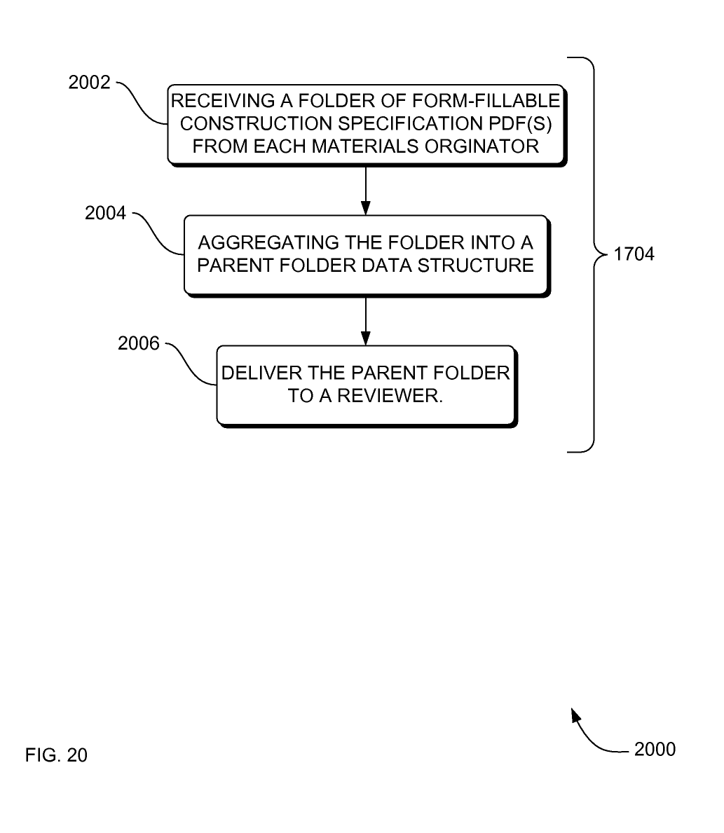

FIG. 20 is a flowchart of a method 2000 to aggregate a plurality of form-fillable construction specification PDF(s), according to an embodiment. Method 2000 is one embodiment of aggregating 1704 a plurality of form-fillable construction specification PDF(s) in FIG. 17 above. Method 2000 solves the need in the art to improve the organization and architecture of workflow of multimedia objects between heterogeneous computer systems.

Some embodiments of method 2000 include receiving 2002 at least one folder of form-fillable construction specification PDF(s) from each of the plurality of sub-contractors 2002.

Some embodiments of method 2000 include aggregating 2004 the folders into a project (or parent) folder data structure. The project folder data structure is on a computer-accessible medium. The aggregating 2004 is performed by the general contractor.

Some embodiments of method 2000 include delivering 2006 the parent folder of the form-fillable construction specification PDF(s) to a professional reviewer.

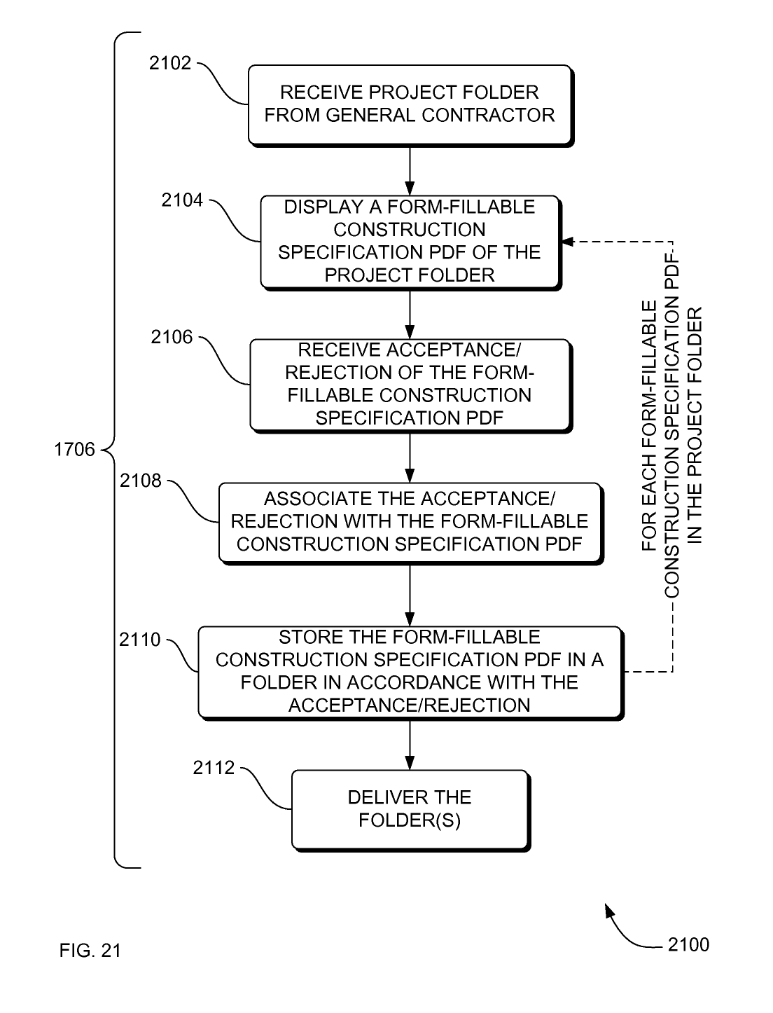

FIG. 21 is a flowchart of a method 2100 to determine the acceptance/rejection of each of the plurality of form-fillable construction specification PDF(s), according to an embodiment. Method 2100 is one embodiment of directing 1706 the processor to determine the acceptance/rejection of each of the plurality of form-fillable construction specification PDF(s) in FIG. 17 above. Method 2100 solves the need in the art to improve the organization and architecture of workflow of multimedia objects between heterogeneous computer systems.

Some embodiments of method 2100 include receiving 2102 a project folder from the general contractor.

Method 2100 includes the remaining actions of method 2100 that are performed once for each form-fillable construction specification PDF in the project folder.

Some embodiments of method 2100 include displaying 2104 the form-fillable construction specification PDF to a professional reviewer.

Some embodiments of method 2100 include receiving 2106 an acceptance/rejection of the form-fillable construction specification PDF.

Some embodiments of method 2100 include associating 2108 the acceptance/rejection with the form-fillable construction specification PDF.

Some embodiments of method 2100 include storing 2110 the form-fillable construction specification PDF in a folder associated with rejection or saving the form-fillable construction specification PDF in a folder associated with acceptance depending on the acceptance/rejection.

Some embodiments of method 2100 include delivering 2112 the folder associated with rejection and the folder associated with acceptance.

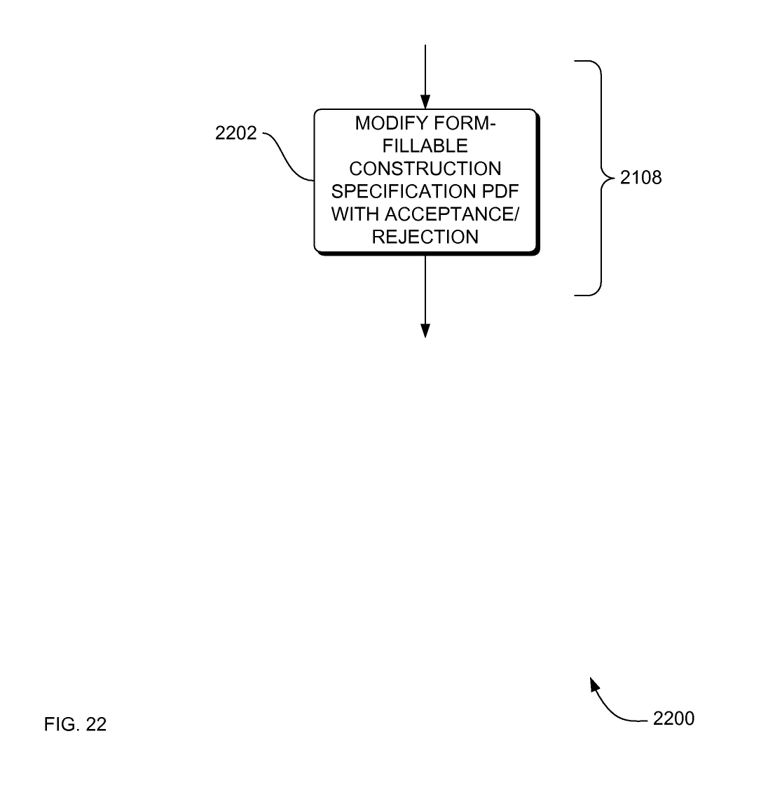

FIG. 22 is a flowchart of a method 2200 to associate the acceptance/rejection with the form-fillable construction specification PDF, according to an embodiment. Method 2200 is one embodiment of associating 2108 the acceptance/rejection with the form-fillable construction specification PDF in FIG. 21 above. Method 2200 solves the need in the art to improve the organization and architecture of workflow of multimedia objects between heterogeneous computer systems.

Method 2200 includes modifying 2202 the form-fillable construction specification PDF with the acceptance/rejection.

FIG. 23 is a flowchart of a method 2300 of delivery of accepted/rejected form-fillable construction specification PDFs, according to an embodiment. Method 2300 is one embodiment of delivering 1708 in FIG. 17 above. Method 2300 solves the need in the art to improve the organization and architecture of workflow of multimedia construction specific documents between heterogeneous computer systems.

Method 2300 includes delivering 2302 each of the form-fillable construction specification PDF(s) that have accepted/rejected and the delivering the acceptance/rejection of each of the accepted/rejected form-fillable construction specification PDF(s) to the general contractor.

FIG. 24 is a flowchart of a method 2400 of delivery of accepted/rejected form-fillable construction specification PDFs, according to an embodiment. Method 2400 is one embodiment of delivering 1708 in FIG. 17 above. Method 2400 solves the need in the art to improve the organization and architecture of workflow of multimedia construction specific documents between heterogeneous computer systems.

Method 2400 includes delivering 2402 each of the accepted/rejected form-fillable construction specification PDF(s) and the acceptance/rejection of each of the accepted/rejected form-fillable construction specification PDF(s) to one or more of the sub-contractors, such as the sub-contractor that that added the job-specific information to the form-fillable construction specification PDF in action 1702 above.

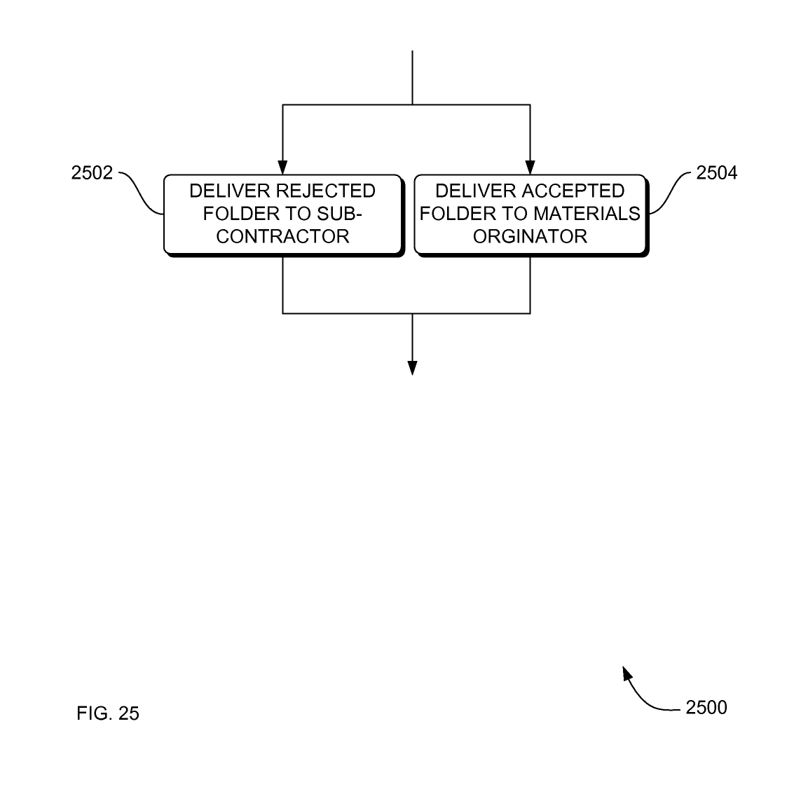

FIG. 25 is a flowchart of a method 2500 to deliver the folder associated with rejection and the folder associated with acceptance, according to an embodiment. Method 2500 is one embodiment of delivering 2112 the folder associated with rejection and the folder associated with acceptance in FIG. 21 above. Method 2500 solves the need in the art to improve the organization and architecture of workflow of multimedia objects between heterogeneous computer systems.

Method 2500 includes delivering 2502 to a sub-contractor the folder associated with rejection and delivering 2504 to the sub-contractor the folder associated with acceptance.

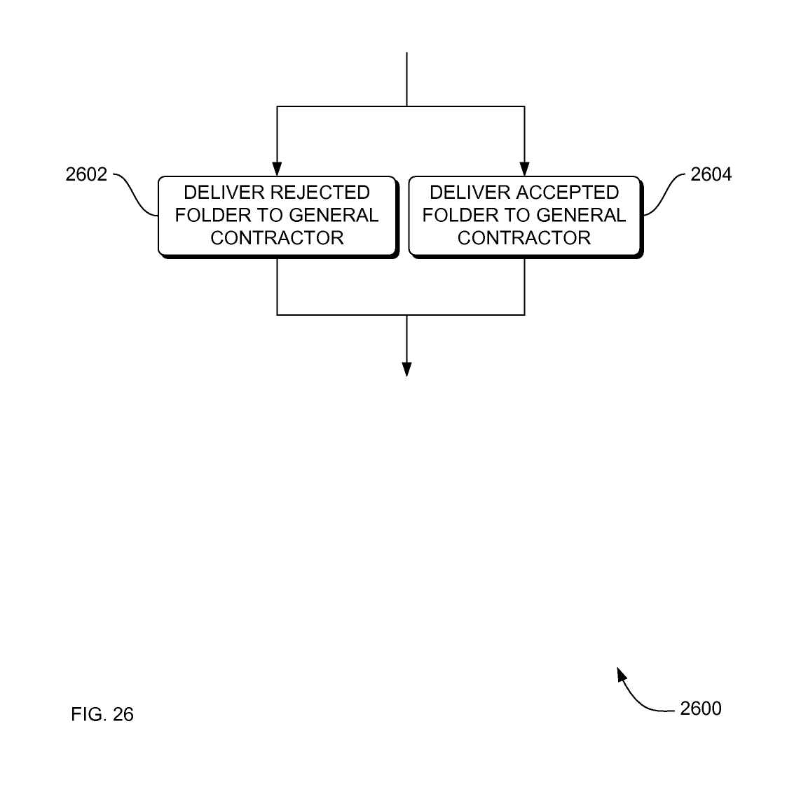

FIG. 26 is a flowchart of a method 2600 to deliver the folder associated with rejection and the folder associated with acceptance, according to an embodiment. Method 2600 is one embodiment of delivering 2112 the folder associated with rejection and the folder associated with acceptance in FIG. 21 above. Method 2600 solves the need in the art to improve the organization and architecture of workflow of multimedia objects between heterogeneous computer systems.

Method 2600 includes delivering 2602 to a general contractor the folder associated with rejection and delivering 2604 to the general contractor the folder associated with acceptance.

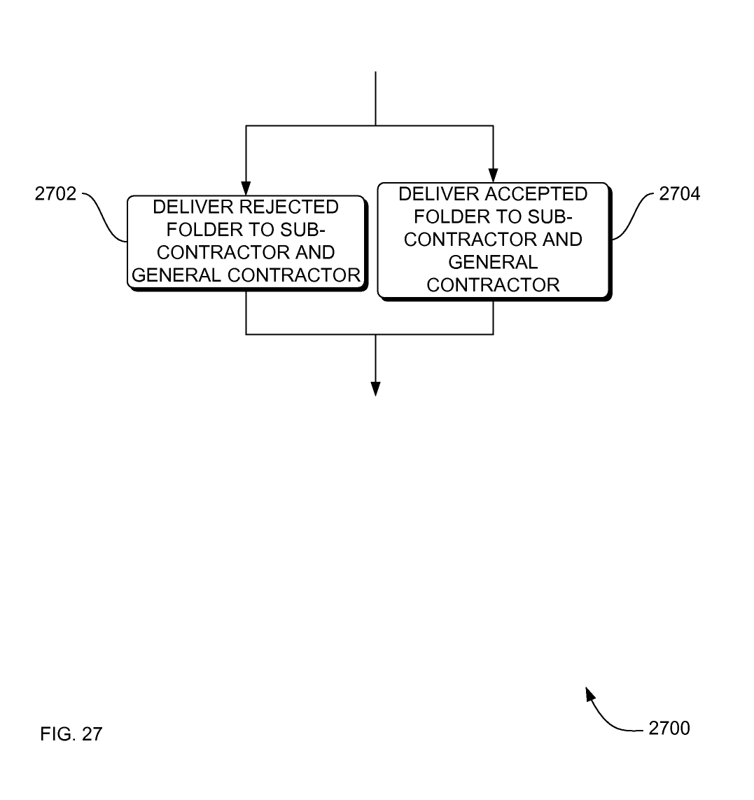

FIG. 27 is a flowchart of a method 2700 to deliver the folder associated with rejection and the folder associated with acceptance, according to an embodiment. Method 2700 is one embodiment of delivering 2112 the folder associated with rejection and the folder associated with acceptance in FIG. 21 above. Method 2700 solves the need in the art to improve the organization and architecture of workflow of multimedia objects between heterogeneous computer systems.

Method 2700 includes delivering 2702 to a general contractor and to the sub-contractor the folder associated with rejection and delivering 2704 to the general contractor and to the sub-contractor the folder associated with acceptance.

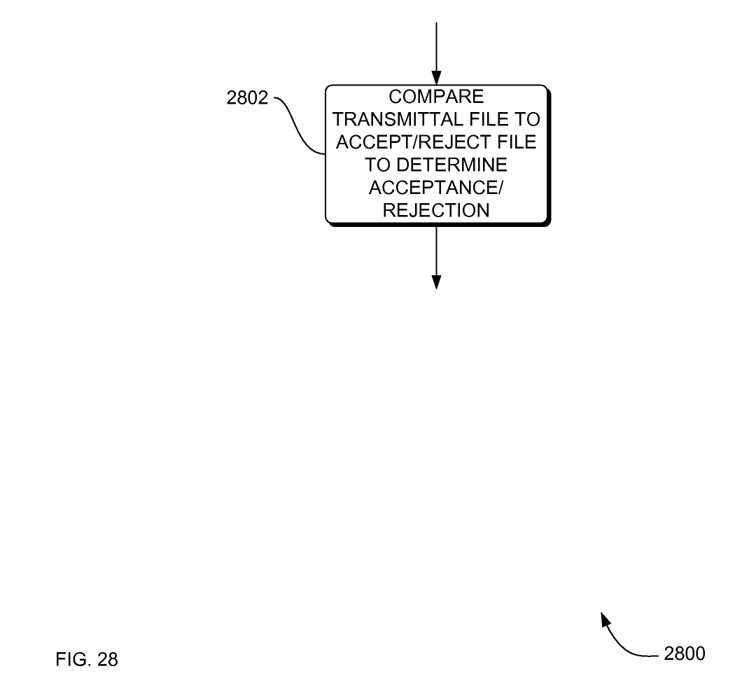

FIG. 28 is a flowchart of a method 2800 to compare a transmittal file to a file in the project folder according to an embodiment. Method 2800 solves the need in the art to improve the organization and architecture of workflow of multimedia objects between heterogeneous computer systems.

Some embodiments of method 2800 include comparing 2802 a transmittal file to a file in the reject/accept folder of the project folder. The comparison 2802 indicates the acceptance/rejection of the transmittal file.

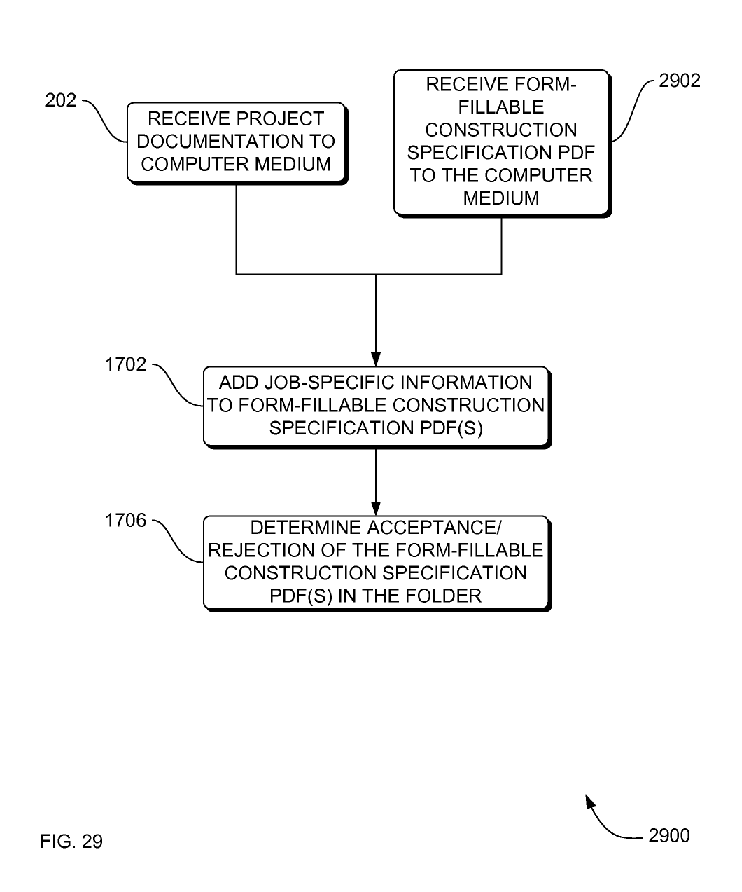

FIG. 29 is a flowchart of a method 2900 to exchange in a predetermined architecture of form-fillable construction specification PDF interchange, according to an embodiment. Method 2900 solves the need in the art to improve the organization and architecture of workflow of multimedia objects between heterogeneous computer systems.

Some embodiments of method 2900 include receiving 202 project documentation to a computer-accessible medium. In one embodiment, the project documentation includes construction project documentation. Receiving 202 is one embodiment of the receiver 102 of project information 104 in FIG. 1.

Method 2900 also includes receiving 2902 one or more form-fillable construction specification PDF(s) to the computer-accessible medium. Receiving 2902 is one embodiment of the receiver 106 of the one or more form-fillable construction specification PDF, or other graphic document(s) 108. The receiving actions 202 and 2902 can be performed in any order, such as simultaneously, or in sequential order in which action 2902 is performed before action 202.

Some embodiments of method 2900 include adding 1702 job-specific information to a plurality of form-fillable construction specification PDF(s). The plurality of form-fillable construction specification PDF(s) have a file name that is in accordance, conformance, and/or in reference to a construction specification document nomenclature. The construction specification document nomenclature is discussed in further detail below. The adding 1702 is performed upon each of the plurality of form-fillable construction specification PDF(s) by a sub-contractor; wherein the plurality of form-fillable construction specification PDF(s) are added by a plurality of sub-contractors.

Some embodiments of method 2900 include determining 1706 an acceptance/rejection of each of the plurality of form-fillable construction specification PDF(s) in reference to the job-specific information in each of the plurality of form-fillable construction specification PDF(s).

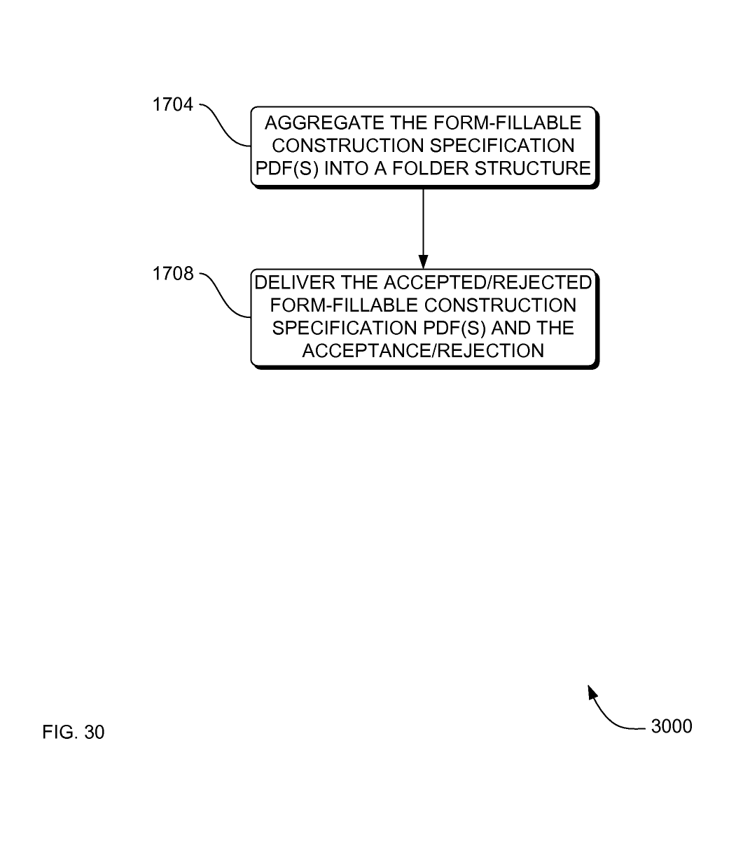

FIG. 30 is a flowchart of a method 3000 of actions additional to method 2900 in FIG. 29 above, according to an embodiment. Method 3000 solves the need in the art to improve the organization and architecture of workflow of multimedia objects between heterogeneous computer systems.

Some embodiments of method 3000 include aggregating 1704 the plurality of form-fillable construction specification PDF(s) into a folder data structure. The folder data structure is located on a computer-accessible medium. In some embodiments, the aggregating is performed by a general contractor, which can be a person or an inanimate object such as a computer.

Method 3000 also includes delivering 1708 each of the accepted/rejected form-fillable construction specification PDF(s) and delivering the acceptance/rejection of each of the accepted/rejected form-fillable construction specification PDF(s). In some embodiments such as described in FIG. 23 above, the delivery is to the general contractor. In some embodiments such as described in FIG. 24 above, the delivery is to one of the plurality of sub-contractors that added the job-specific information to the form-fillable construction specification PDF in action 1702 above.

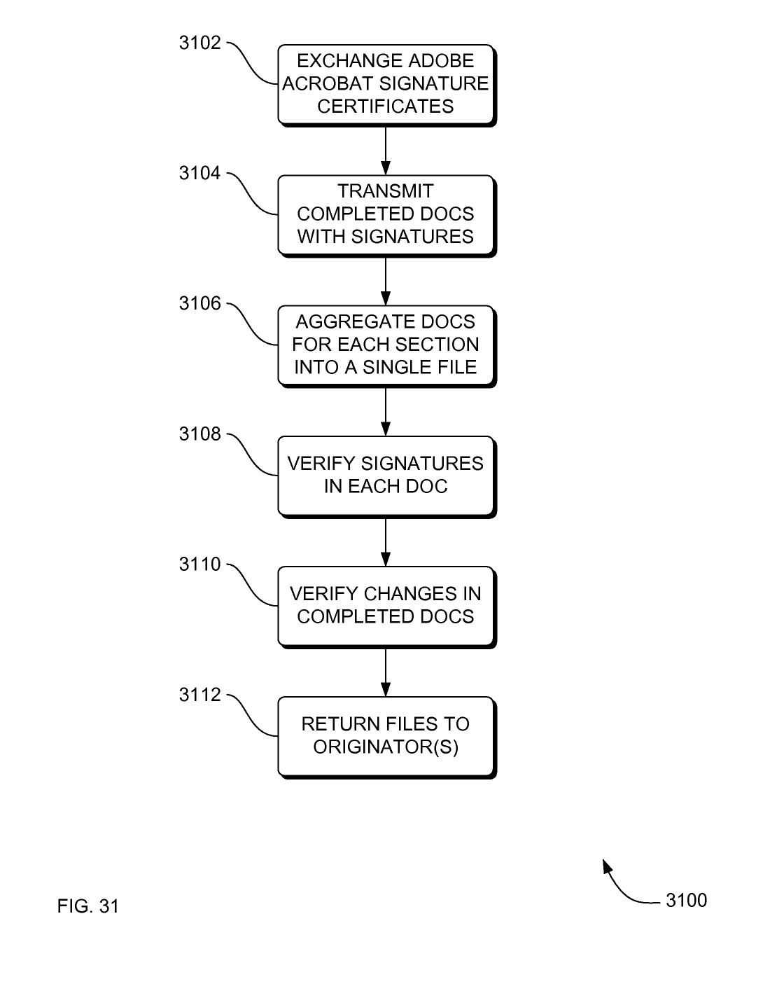

FIG. 31 is a flowchart of a method 3100 to exchange form-fillable construction specification PDF(s), according to an embodiment. Method 3100 solves the need in the art to improve the organization and architecture of workflow of multimedia construction specific documents between heterogeneous computer systems in the construction industry.

Some embodiments of method 3100 include exchanging 3102 Adobe Acrobat signature certificates between the computers that will be or could be involved in the exchange of job-specific construction specification information (JSCSI).

Some embodiments of method 3100 include transmitting 3104 completed PDF job-specific construction specification documents with signatures.

Some embodiments of method 3100 include aggregating 3106 PDF job-specific construction specification documents for each section into a single file.

Some embodiments of the transmission 3104 and aggregating 3106 include transmitting and assembling (e.g. aggregating) all PDF document(s) according to software file format. In some embodiments, schedules are transmitted 3104 completely in a single file.

Some embodiments of method 3100 include verifying 3108 authenticity of signature(s) in each PDF job-specific construction specification document that are received from either a submitting or an approving authority. Some embodiments of method 3100 include verifying changes in completed docs. In one embodiment, the changes are verified 3110 by running a document comparator feature/function of Adobe Acrobat to verify changes in all documents. In some versions of Adobe Acrobat, the document comparator feature is located on the menus at “documents” and then “compare documents.” The PDF job-specific construction specification documents in the subdirectory “Project Transmitted File” is compared to the PDF job-specific construction specification document in “Returned File” subdirectory.

Some embodiments of method 3100 include returning 3112 the PDF job-specific construction specification documents to the originators. In some embodiments, the appropriate PDF job-specific construction specification document is returned to the originator of the PDF job-specific construction specification document and material specified in the PDF job-specific construction specification document is ordered by the originator.

In some embodiments, methods 200-3100 are implemented as a computer data signal embodied in a carrier wave, that represents a sequence of instructions which, when executed by a processor, such as processor 3204 in FIG. 32, cause the processor to perform the respective method. In other embodiments, methods 200-3100 are implemented as a computer-accessible medium having executable instructions capable of directing a processor, such as processor 3204 in FIG. 32, to perform the respective method. In varying embodiments, the medium is a magnetic medium, an electronic medium, or an optical medium.

### Hardware and Operating Environment

FIG. 32 is a block diagram of a hardware and operating environment 3200 in which different embodiments can be practiced. The description of FIG. 32 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Computer 3202 includes a processor 3204, commercially available from Intel, Motorola, Cyrix and others. Computer 3202 also includes random-access memory (RAM) 3206, read-only memory (ROM) 3208, and one or more mass storage devices 3210, and a system bus 3212, that operatively couples various system components to the processing unit 3204. The memory 3206, 3208, and mass storage devices, 3210, are types of computer-accessible media. Mass storage devices 3210 are more specifically types of nonvolatile computer-accessible media and can include one or more hard disk drives, floppy disk drives, optical disk drives, and tape cartridge drives. The processor 3204 executes computer programs stored on the computer-accessible media.

Computer 3202 can be communicatively connected to the Internet 3214 via a communication device 3216. Internet 3214 connectivity is well known within the art. In one embodiment, a communication device 3216 is a modem that responds to communication drivers to connect to the Internet via what is known in the art as a “dial-up connection.” In another embodiment, a communication device 3216 is an Ethernet® or similar hardware network card connected to a local-area network (LAN) that itself is connected to the Internet via what is known in the art as a “direct connection” (e.g., T1 line, etc.).

A user enters commands and information into the computer 3202 through input devices such as a keyboard 3218 or a pointing device 3220. The keyboard 3218 permits entry of textual information into computer 3202, as known within the art, and embodiments are not limited to any particular type of keyboard. Pointing device 3220 permits the control of the screen pointer provided by a graphical user interface (GUI) of operating systems such as versions of Microsoft Windows®. Embodiments are not limited to any particular pointing device 3220. Such pointing devices include mice, touch pads, trackballs, remote controls and point sticks. Other input devices (not shown) can include a microphone, joystick, game pad, satellite dish, scanner, or the like.

In some embodiments, computer 3202 is operatively coupled to a display device 3222. Display device 3222 is connected to the system bus 3212. Display device 3222 permits the display of information, including computer, video and other information, for viewing by a user of the computer. Embodiments are not limited to any particular display device 3222. Such display devices include cathode ray tube (CRT) displays (monitors), as well as flat panel displays such as liquid crystal displays (LCD's). In addition to a monitor, computers typically include other peripheral input/output devices such as printers (not shown). Speakers 3224 and 3226 provide audio output of signals. Speakers 3224 and 3226 are also connected to the system bus 3212.

Computer 3202 also includes an operating system (not shown) that is stored on the computer-accessible media RAM 3206, ROM 3208, and mass storage device 3210, and is and executed by the processor 3204. Examples of operating systems include Microsoft Windows®, Apple MacOS®, Linux®, UNIX®. Examples are not limited to any particular operating system, however, and the construction and use of such operating systems are well known within the art.

Embodiments of computer 3202 are not limited to any type of computer 3202. In varying embodiments, computer 3202 comprises a PC-compatible computer, a MacOS®-compatible computer, a Linux®-compatible computer, or a UNIX®-compatible computer. The construction and operation of such computers are well known within the art.

Computer 3202 can be operated using at least one operating system to provide a graphical user interface (GUI) including a user-controllable pointer. Computer 3202 can have at least one web browser application program executing within at least one operating system, to permit users of computer 3202 to access an intranet, extranet or Internet world-wide-web pages as addressed by Universal Resource Locator (URL) addresses. Examples of browser application programs include Netscape Navigator® and Microsoft Internet Explorer®.

The computer 3202 can operate in a networked environment using logical connections to one or more remote computers, such as remote computer 3228. These logical connections are achieved by a communication device coupled to, or a part of, the computer 3202. Embodiments are not limited to a particular type of communications device. The remote computer 3228 can be another computer, a server, a router, a network PC, a client, a peer device or other common network node. The logical connections depicted in FIG. 32 include a local-area network (LAN) 3230 and a wide-area network (WAN) 3232. Such networking environments are commonplace in offices, enterprise-wide computer networks, intranets, extranets and the Internet.

When used in a LAN-networking environment, the computer 3202 and remote computer 3228 are connected to the local network 3230 through network interfaces or adapters 3234, which is one type of communications device 3216. Remote computer 3228 also includes a network device 3236. When used in a conventional WAN-networking environment, the computer 3202 and remote computer 3228 communicate with a WAN 3232 through modems (not shown). The modem, which can be internal or external, is connected to the system bus 3212. In a networked environment, program modules depicted relative to the computer 3202, or portions thereof, can be stored in the remote computer 3228.

Computer 3202 also includes power supply 3238. Each power supply can be a battery.

### Apparatus Implementation

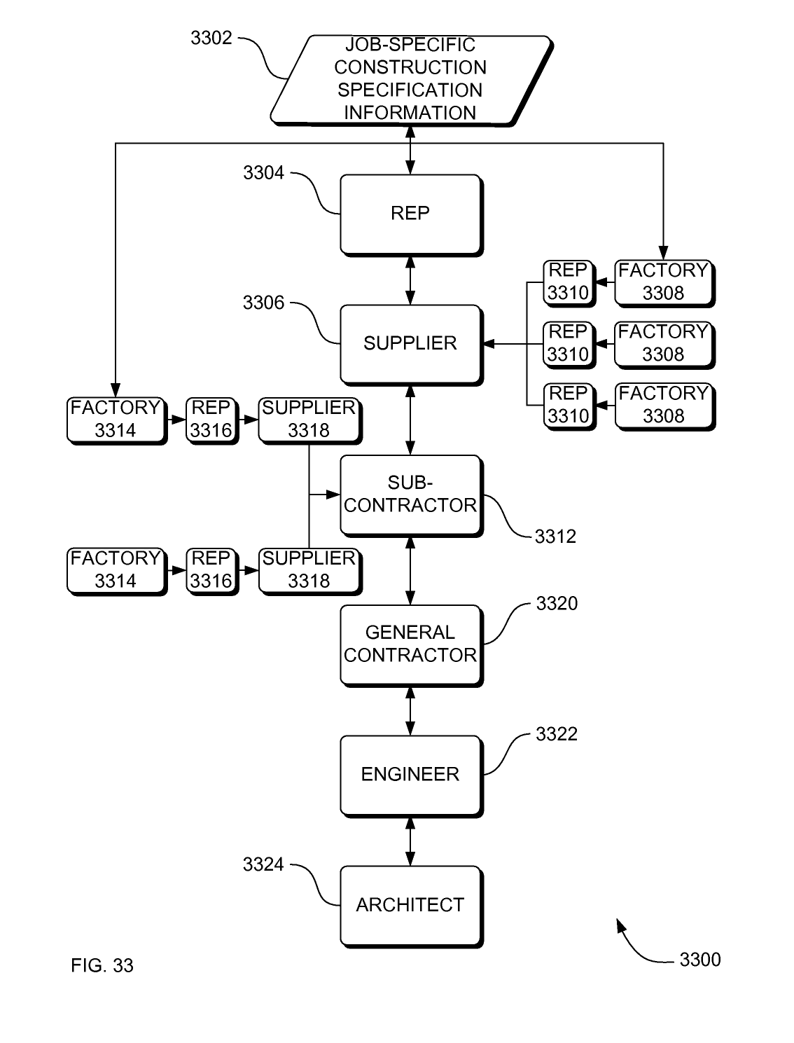

Referring to FIGS. 33-43, particular implementations are described in conjunction with the system overview in FIG. 1 and the methods described in conjunction with FIGS. 2-31.

FIG. 33 is a block diagram of a system 3300 operable to manage construction information between the various actors of a construction project. In system 3300, job-specific construction specification information from multiple sources is aggregated through one or more layers of suppliers of construction materials in the bidding process for a particular construction project, thus system 3300 solves the need to improve the organization and architecture of workflow of multimedia objects between heterogeneous computer systems in the construction industry.

In system 3300, job-specific construction specification information (JSCSI) 3302 is delivered to and received by a representative 3304. The JSCSI 3302 is information that specifies materials required for a particular construction project.

The JSCSI 3302 is passed along from the representative 3304 to a supplier 3306 of construction materials. In some embodiments, one or more construction-materials factories 3308 deliver JSCSI 3302 to one or more representatives 3310, which in turn passes the JSCSI 3302 to the supplier 3306.

The supplier 3306 of construction materials delivers the JSCSI 3302 to a sub-contractor 3312. In some embodiments, one or more construction-materials factories 3314 deliver JSCSI 3302 to one or more representatives 3316, which in turn passes the JSCSI 3302 to one or more suppliers 3318, which in turn pass the JSCSI 3302 to the sub-contractor 3312.

In system 3300, the sub-contractor 3312 delivers the JSCSI 3302 to a general contractor 3320. In some embodiments, one or more construction-materials factories deliver JSCSI 3302 to one or more representatives, which in turn passes the JSCSI 3302 to one or more suppliers, which in turn pass the JSCSI 3302 to one or more sub-contractors 3312, which in turn passes the JSCSI 3302 to the general contractor 3320.

The general contractor 3320 delivers the JSCSI 3302 to one or more engineer(s) 3322, to review, modify and/or approve the JSCSI 3302. The engineer(s) 3322 deliver the reviewed/modified/approved JSCSI 3302 to one or more architect(s) 3324 who review, approve and/or reject specific line items in the JSCSI 3302. The architect(s) 3324 pass the approved/rejected JSCSI 3302 back to preceding parties in the system, such as the representative 3304.

The role of the combiner 110 in FIG. 1 is performed by the representative 3304, the supplier 3306, the factory(s) 3308, the representative(s) 3310, the sub-contractor 3312, the factory(s) 3314, the representatives 3316, the supplier(s) 3318, and the general contractor. In FIG. 33, the functions of the combiner 110 are tailored specifically to the process of construction bidding and specification in the one or more multimedia object(s) 108 and the project information 104 of FIG. 1 are job-specific construction specification information (JSCSI) 3302. The factory(s) 3308 and 3314, the representative(s) 3304, 3310, 3316 and the supplier(s) 3306, 3318 perform method 1500 in FIG. 5 above and method 1600 in FIG. 16 above.

Apparatus components of the FIGS. 2-30 can be embodied as computer hardware circuitry or as a computer-readable program, or a combination of both. In another embodiment, system is implemented in an application service provider (ASP) system.

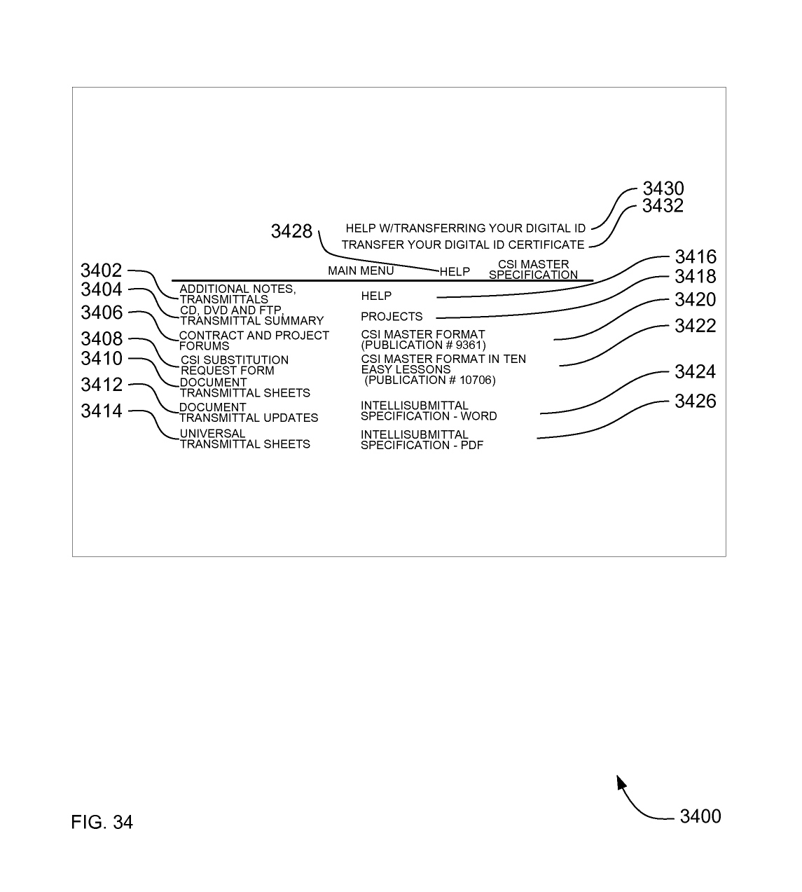

FIG. 34 is a block diagram of a main menu graphical user interface 3400, according to an embodiment. The main menu graphical user interface 3400 is the main menu of a particular embodiment. From the main menu graphical user interface 3400, all functions can be accessed. Menu options in the main menu graphical user interface 3400 include additional notes 3402, CD, DVD and FTP transmittal summary 3404, contract and project forms 3406, CSI substitution request forms 3408, document transmittal sheets 3410, document transmittal updates 3412 and universal transmittal sheets 3414. Menu options in the main menu graphical user interface 3400 also include help 3416, projects 3418, CSI Master Format Publication 3420, CSI Format in 10 Easy Lessons Publication 3422, Intellisubmittal specifications in Word format 3424 and Intellisubmittal specifications in PDF format 3426.

The main menu graphical user interface 3400 drives the entire function of the software. In one example of a workflow, a user selects Document Transmittal Sheets 3410. From the Document Transmittal Sheets 3410, a document transmittal sheet that corresponds to the section division and level (e.g. known as Level 1, 2 and 3 formats) out of the construction standards institute formats for the items for which the user is submitting. The user places the document transmittal sheet through the special save command into an organizer file. After completing the document transmittal sheet, the document transmittal sheet is used as a cover sheet transmittal.

The additional notes transmittal 3402 is a page that is placed behind the cover sheet transmittal to provide additional area to add notes for an approval of the item. The CD, DVD and FTP transmittal summary 3402 is a list of the summary items in the entire transfer. The CSI substitution request form 3408 is a form to submit a proposal to an architect or engineer prior to the bid. The document transmittal sheets 3410 are transmittal sheets in accordance to the CSI specifications; of which one sheet corresponds to each CSI specification. In some embodiments, the CSI specification prescribes approximately 6955 sheets. Document transmittal update 3412 is a menu providing document transmittal sheets that have been updated by CSI. The universal transmittal sheets 3414 provides document transmittals of area(s) that have not been documented by the CSI transmittal; comprised of two different products. 1) the 50 CSI format and 2) the 16 or 17 CSI format so that this can be used completely across the board.

The Help 3416 provides Help file for the application. The Help selection 3428 is context sensitive to that particular menu. The Projects 3418 provides a screen that assembles projects and prepares a transmittal. The CSI Master Format Publication 3420 provides the document CSI Master Format Publication for reference use and purposes. The CSI format in 10 Easy Lessons Publications 3422 provides information on how the CSI format is organized conceptionally. The Intellisubmittal Specification in Word format 3424 provides a specification to be used by the architect or engineer in their specifications. The Intellisubmittal Specification in PDF format 3426 provides a specification to be used by the architect or engineer in their specifications.

The Digital ID area 3430 provides help information on the transfer of visual identification (ID). The Digital ID area 3432 provides transfer of visual ID to verify completed tasks and functions.

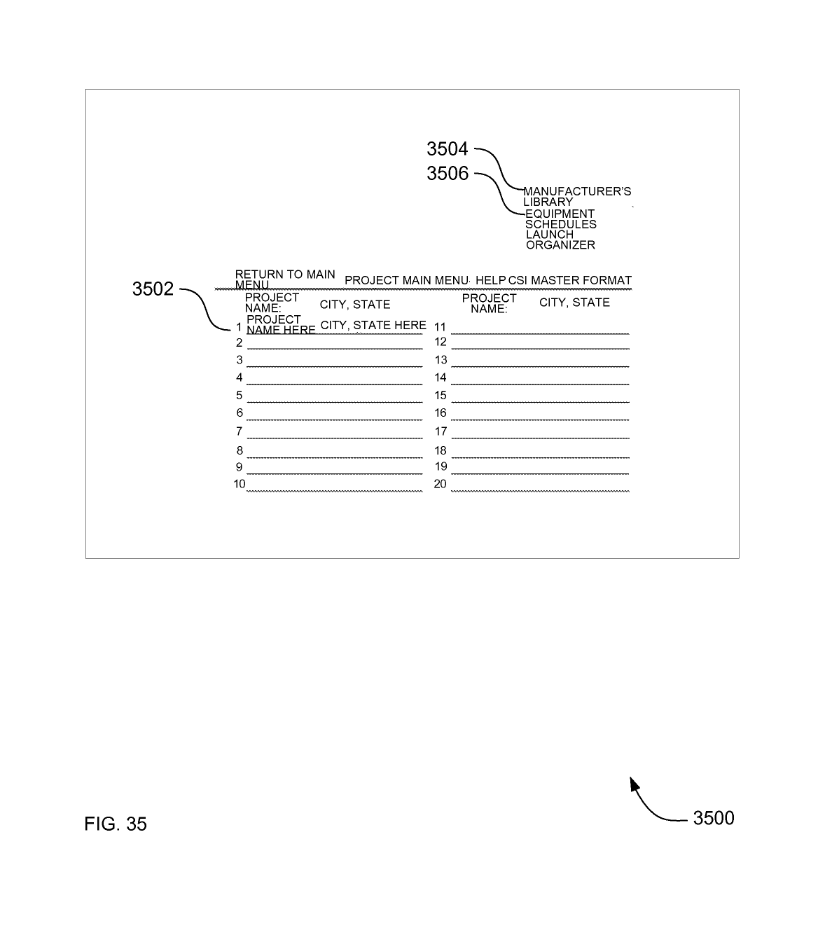

FIG. 35 is a block diagram of a project main menu graphical user interface 3500, according to an embodiment. The project main menu graphical user interface 3500 provides access to projects, such as project 1 (item 3502). From each of the projects listed in the project main menu graphical user interface 3500, each of the projects can be transmitted, stored and held approved and rejected submittals, maintenance, operations manuals, and other construction documents. The manufactures library 3504 provides storage for raw data in order to submit. The equipment schedules 3506 organizes the individual submittal items for the transmittal in the organizer file to allow reconstruction of the scheduled items as shown in the plan sheets or in the specifications.

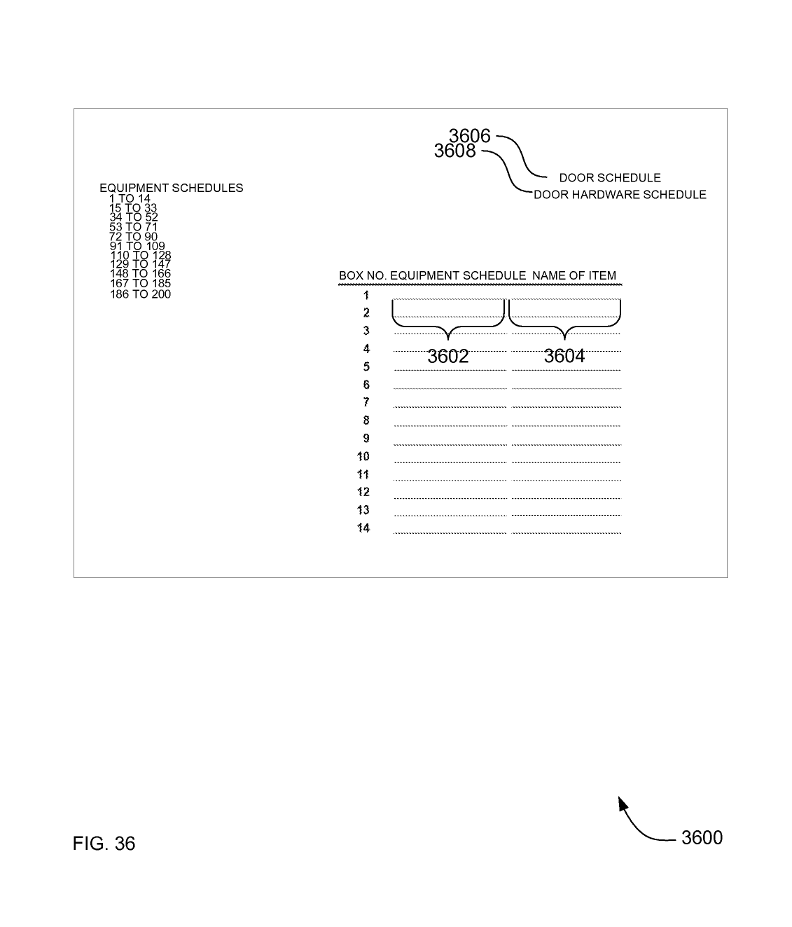

FIG. 36 is a block diagram of an equipment schedule menu page graphical user interface 3600, according to an embodiment. The equipment schedule menu page graphical user interface 3600 includes text fields that can be completed (e.g. filled out) by a user for item descriptions 3602 and item numbers 3604 to submit bids. A door schedule is accessed by a hyperlink 3606 and door hardware schedule is accessed via a hyperlink 3608. The door hardware schedule provides entry for both the door schedules and the individual door hardware schedules.

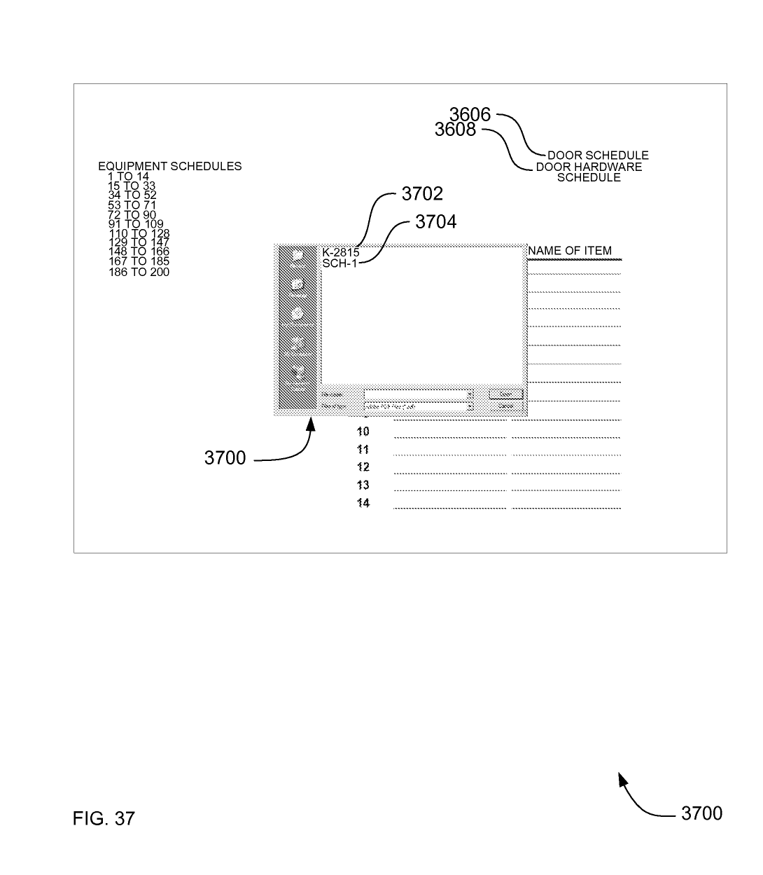

FIG. 37 is a block diagram of an open schedule box graphical user interface 3700, according to an embodiment. The open schedule box graphical user interface 3700 displays a cover sheet file and a schedule file “box 1” (i.e. “Project 1”) in FIG. 36 Each item for a schedule is selected to be zipped up into the cover sheet file.

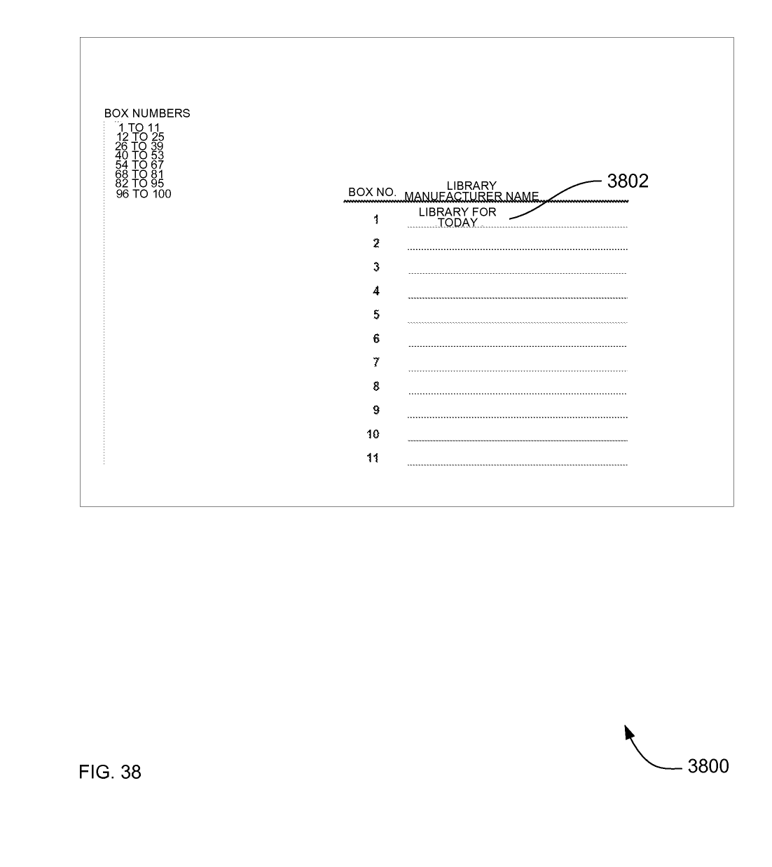

FIG. 38 is a block diagram of a library menu page graphical user interface 3800, according to an embodiment. The library menu page graphical user interface 3800 displays libraries, such as the library 3802 titled “Library for Today,” each one of which holds a different library for a different manufacturer group or manufacturer that is selected by the user. Each of the library items are raw submittals and maintenance operations manuals that can be used in the schedules and submission of files for submission in assisting a user store raw data for the submission in this file.

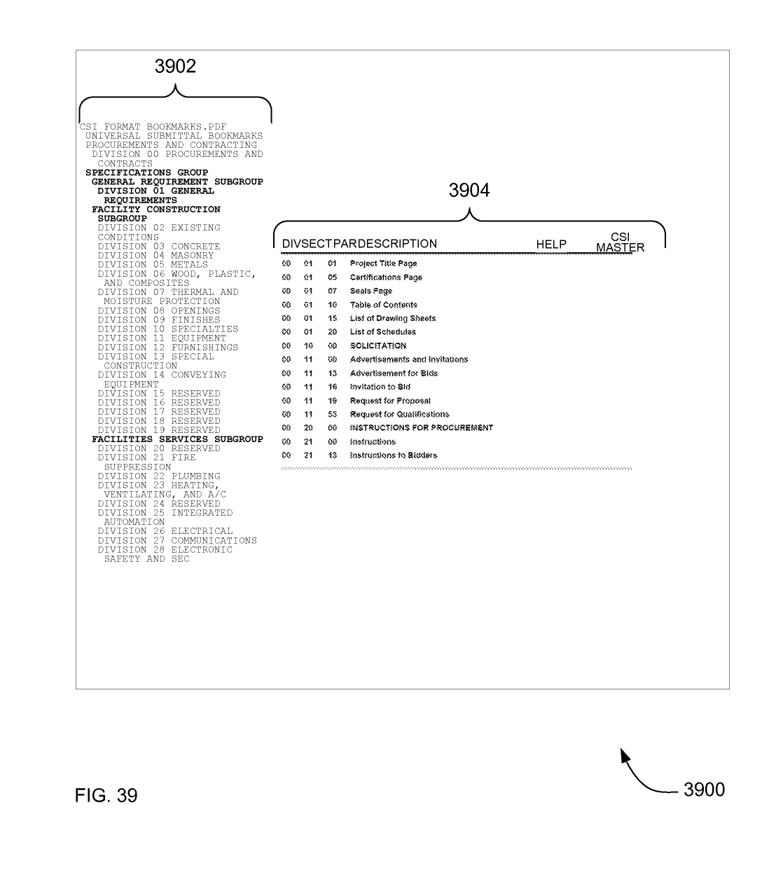

FIG. 39 is a block diagram of a document transmittal sheet library main page graphical user interface 3900, according to an embodiment. The document transmittal sheet library main page graphical user interface 3900 displays a plurality of individual transmittal sheets 3902 and a menu 3904 for accessing the individual transmittal sheets. Each of the transmittal sheets correspond to the actual individual section in a Division Section and paragraph number actually Level 1, Level 2 and Level 3 for each individual item that is being submitted, according to the CSI specifications. From the document transmittal sheet library main page graphical user interface 3900, a cover sheet is accessed; the cover sheet for a bid submission. The user can also attach all bid submission documents to this cover sheet for transmittal to the next level for approval. Thereafter, every item in that specified section will be attached to that sheet. The CSI specifications are published by the Construction Specification Institute of Alexandria, Va.

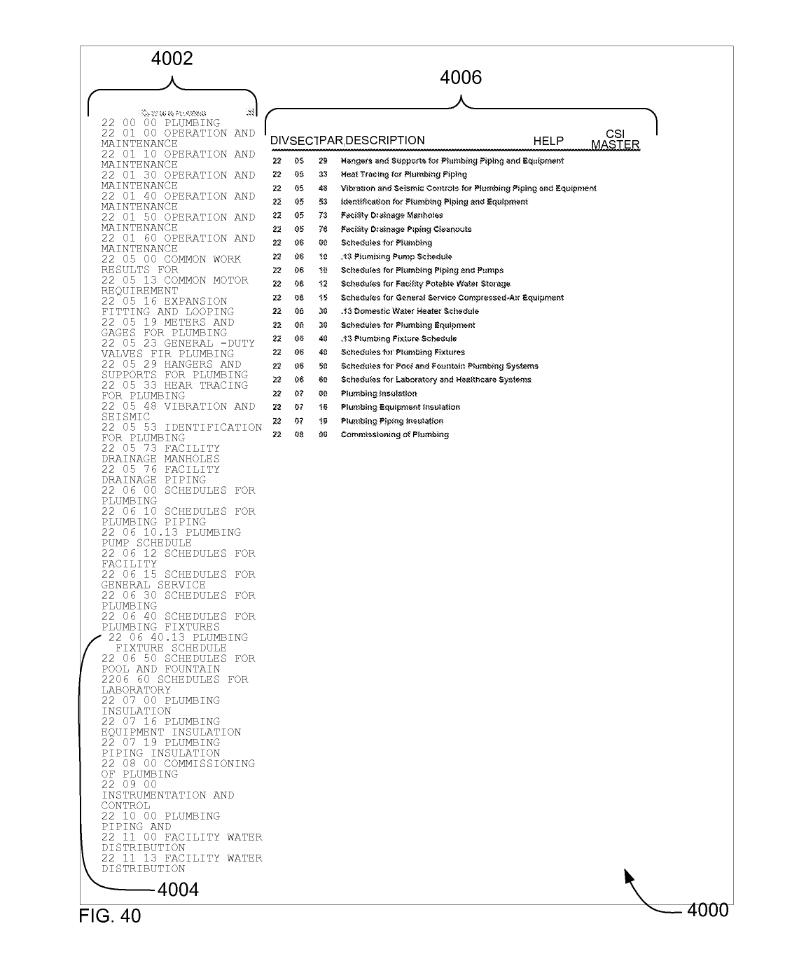

FIG. 40 is a block diagram of a document selection page graphical user interface graphical user interface 4000, according to an embodiment. The document selection page graphical user interface graphical user interface 4000 displays a list 4002 of specification levels, that includes for example the schedule 4004 for paragraph 22 06 40 13 which is a plumbing fixture schedule individual level, 22 06 40 13 which is a plumbing fixture schedule. Clicking on a schedule on the list of schedules 4002 displays the individual levels in 4006, which is a link to that specific cover page. For this example, the plumbing fixtures and then those plumbing fixtures out of the plumbing fixture schedule will be attached to the back of this sheet for transmittal for approval.

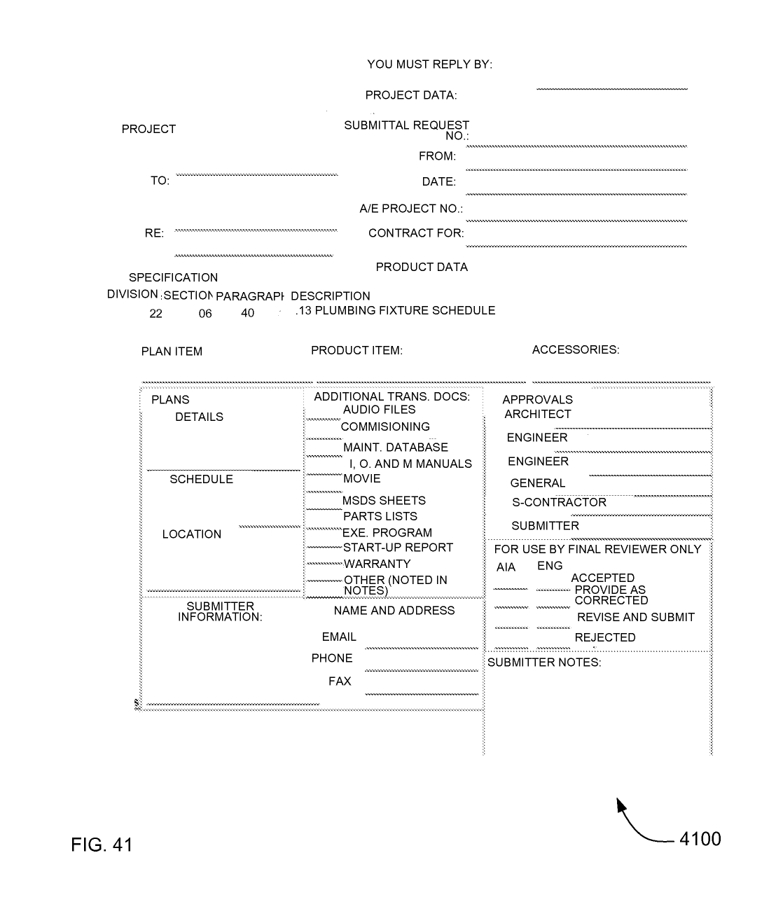

FIG. 41 is a block diagram of a transmittal page graphical user interface 4100, according to an embodiment. The transmittal page graphical user interface 4100 is associated with a specific section. In the example of FIG. 41, the section is 22 06 40 13. All of the submitted items for the section will be attached to this form. Each item in the schedule has it's own cover sheet, e.g. Schedule 1, Schedule 2, etc., etc. until submittals for the entire schedule has been submitted.

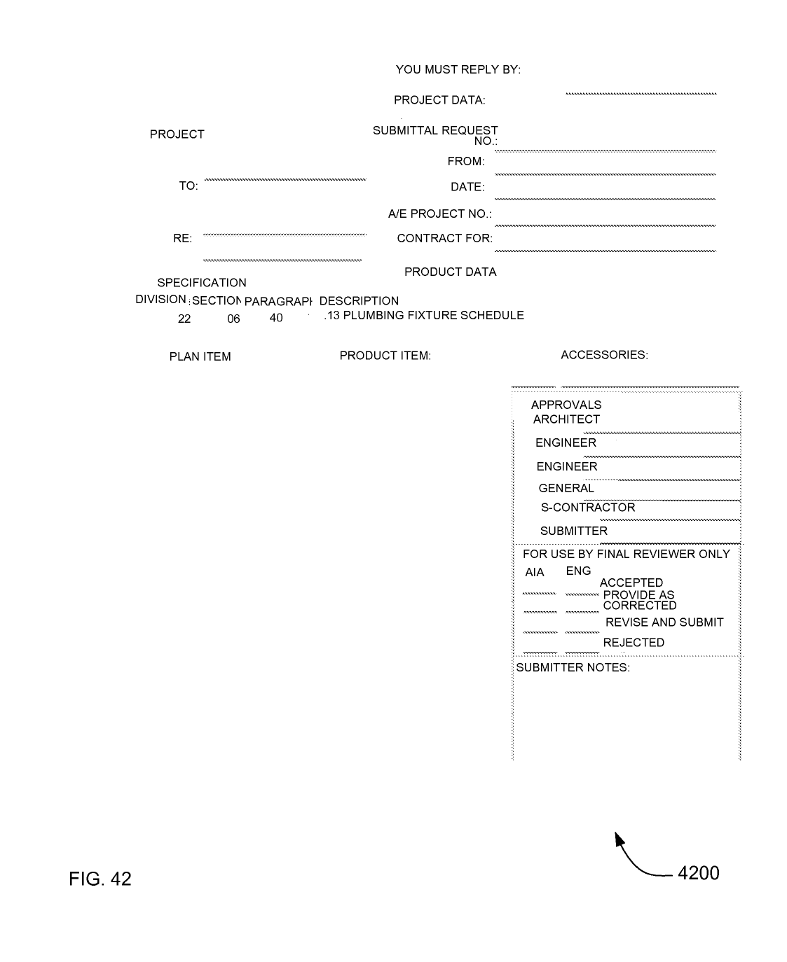

FIG. 42 is a block diagram of additional notes transmittal graphical user interface 4300, according to an embodiment. The additional notes transmittal graphical user interface 4300 provides a mechanism to enter additional notes, approval or update an item or change an item. The additional notes transmittal file is transmitted after the transmittal cover sheet such as 22 06 40 13, which provides more clarification notes on the tasks to be performed in a construction projects or what changes are to be made to a submitted item.

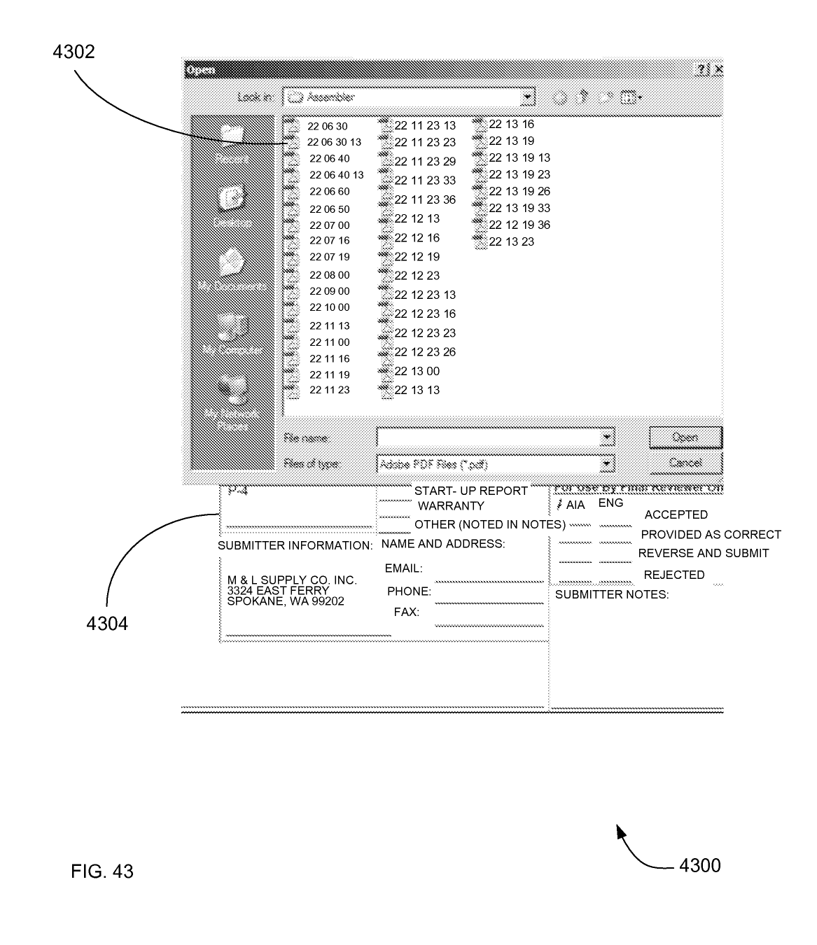

FIG. 43 is a block diagram of an assembler graphical user interface 4300 showing files ready to transmit, according to an embodiment. The assembler graphical user interface 4300 is helpful in the workflow after an item has been organized in the organizer, and thereafter, the item is then deposited in the assembler. The assembler graphical user interface 4300 displays a list 4302 of items in an individual section for which bids are being prepared. This assembler is the box 4304 that assembles the transmittal for transfer to another computer, such as either a CD, FTP, e-mail or the like, which thereafter is either burned to a disk or transferred to another website for further review by approvers.

In the example shown in FIG. 43, several files are being assembled in the assembler in preparation to be transmitted from a supplier to a contractor. From the supplier, the assembled files are transmitted to the contractor and from the contractor the assemble files are transmitted to a consulting authority. In some embodiments, the consulting authority is an architect or an engineer. The assembled files are delivered by FTP, CD and/or e-mail.

Thereafter, the consulting authority will review each one of the documents in the assembled files, and add comments to the documents using a file-editing program such as Adobe Acrobat. The documents are saved with the added comments by the consulting authority on the architect or engineer's computer. The marked-up document is saved in the assembler and in the project file with a designator indicating either approval or disapproval of the consulting authority. The comments are made as shown in FIG. 41 with additional notes and the approval in the approval's signature's section either accepted or no exception taken, corrected, revised or resubmitted or complete disapproval. The consulting authority also adds a digital signature to each of the documents. Each document is placed in the assembler and in a project box under designation of either transmitted, approved or rejected.

The assembled documents are transmitted to a contractor. The contractor compares each of the documents to the original file. The contractor places each document in an in-box and uses a file comparator to compare the received documents to the documents that the contractor had earlier assembled and transmitted to identify changes, comments and/or approvals made by other parties such as the consulting authority. The identified approvals are used to order components in order to fulfill the approved work, and the identified approvals and integrated into a production schedule of the contractor to produce the project. The contractor also forwards the rejected and approved items that involve subcontractor/supplier to the responsible subcontractor/suppliers. The contractor/supplier places the received approvals/rejections and performs the same process of identification that the contractor performed, such as comparing the transmitted documents to the received documents for comments, approvals and rejections. When all parties have received either the approved documents and/or the supplier's corrected documents, some of the rejected documents can be edited and reassembled and retransmitted. This electronic process of managing construction documents that includes assembling, transmitting, reviewing, comparing and transmitting docs to subcontractor can be performed multiple times and iteratively until all parties are in agreement or have agreed to not attempt further negotiation on the matter.

In computer-readable program embodiments, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer 3202 in FIG. 32, or on at least as many computers as there are components.

### CONCLUSION

An architecture of workflow of multimedia objects between heterogeneous computer systems is described that has a technical effect of facilitating the aggregation of multimedia objects, such as text documents, that provides convenient review, approval, rejection and information on the multimedia objects. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application meant to include all object-oriented, database, graphic document and communication environments and alternate technologies which provide the same functionality as described herein.

1. A computer-accessible medium having executable instructions to prepare project information for exchange in a predetermined architecture of multimedia object interchange, the executable instructions capable of directing a processor to perform:
receiving project documentation to a computer-accessible medium;
receiving at least one multimedia object to the computer-accessible medium; and
combining the at least one multimedia object with the project documentation.

2. The computer-accessible medium of claim 1, wherein the executable instructions capable of directing the processor to perform the receiving project documentation further comprise executable instructions capable of directing the processor to perform:
downloading the project documentation.

3. The computer-accessible medium of claim 1, wherein the project documentation further comprises:
construction project documentation.

4. The computer-accessible medium of claim 1, wherein the multimedia object further comprises:
a device-independent document.

5. The computer-accessible medium of claim 5, wherein the device-independent document further comprises:
a form-fillable device-independent document.

6. A computer-accessible medium having executable instructions to exchange graphic documents, the executable instructions capable of directing a processor to perform:
adding job-specific information to a plurality of graphic documents, the plurality of graphic documents having a file name in accordance with a standardized documentation nomenclature, the adding being performed upon each of the plurality of graphic documents by a materials originator; wherein the plurality of graphic documents are added by a plurality of material originators;
aggregating the plurality of graphic documents into a folder data structure, the folder data structure being on a computer-accessible medium, and the aggregating being performed by an aggregator;
determining a disposition of each of the plurality of graphic documents in reference to the job-specific information in each of the plurality of graphic documents; and
delivering each of the disposed plurality of graphic documents and the disposition of each of the disposed plurality of graphic documents to the one of the plurality of material originators that added the job-specific information to the graphic document.

7. The computer-accessible medium of claim 6, wherein the executable instructions capable of directing the processor to deliver further comprise:
delivering each of the disposed plurality of graphic documents and the disposition of each of the disposed plurality of graphic documents to the aggregator.

8. The computer-accessible medium of claim 6, wherein the executable instructions capable of directing the processor to add the job-specific information to the plurality of graphic documents further comprise executable instructions capable of directing the processor to perform:
for each of the graphic documents of one of the plurality of materials originator:
receiving an indication from an operator of a computer of an item in the standardized documentation nomenclature;
displaying a graphic document of the item;
receiving the job-specific information from the operator;
modifying the graphic document by addition of the job-specific information of the job-specific information to the graphic document;
adding a submittal page to the graphic document; and
storing the graphic document in the folder data structure on the computer-accessible medium with the file name in accordance with the item in the standardized documentation nomenclature, and
delivering the folder of the graphic documents to the aggregator.

9. The computer-accessible medium of claim 6, wherein the executable instructions capable of directing the processor to aggregate the plurality of graphic documents further comprise executable instructions capable of directing the processor to perform:
receiving at least one folder of graphic documents from each of the plurality of materials originators;
aggregating the folders into a project folder data structure, the project folder data structure being on a computer-accessible medium, and the aggregating being performed by the aggregator; and
delivering the parent folder of the graphic documents to a professional reviewer.

10. The computer-accessible medium of claim 6, wherein the executable instructions capable of directing the processor to determine the disposition of each of the plurality of graphic documents further comprise executable instructions capable of directing the processor to perform:
receiving a project folder from the aggregator;
for each graphic document in the project folder:
presenting the graphic document to a professional reviewer;
receiving a disposition of the graphic document;
associating the disposition with the graphic document; and
storing the graphic document in a folder associated with rejection disposition or saving the graphic document in a folder associated with acceptance disposition depending on the disposition,
delivering the folder associated with rejection disposition and the folder associated with acceptance disposition.

11. The computer-accessible medium of claim 10, wherein the executable instructions capable of directing the processor to associate the disposition with the graphic document further comprise executable instructions capable of directing the processor to perform:
modifying the graphic document with the disposition.

12. The computer-accessible medium of claim 10, wherein the executable instructions capable of directing the processor to deliver the folder associated with rejection disposition and the folder associated with acceptance disposition further comprise executable instructions capable of directing the processor to perform:
delivering to a material originator the folder associated with rejection disposition and the folder associated with acceptance disposition.

13. The computer-accessible medium of claim 10, wherein the executable instructions capable of directing the processor to deliver the folder associated with rejection disposition and the folder associated with acceptance disposition further comprise executable instructions capable of directing the processor to perform:
delivering to the aggregator the folder associated with rejection disposition and the folder associated with acceptance disposition.

14. The computer-accessible medium of claim 10, wherein the executable instructions capable of directing the processor to deliver the folder associated with rejection disposition and the folder associated with acceptance disposition further comprise executable instructions capable of directing the processor to perform:
delivering to the aggregator and a material originator the folder associated with rejection disposition and the folder associated with acceptance disposition.

15. The computer-accessible medium of claim 10, wherein the executable instructions further comprise executable instructions capable of directing the processor to perform:
comparing transmittal file to file in the reject/accept folder of the project folder depending upon disposition of review, and save in folder in reference to accept/reject.

16. The computer-accessible medium of claim 10, wherein the aggregator further comprises a contractors wherein the reviewer further comprises a contractor,
wherein the job-specific information further comprises job-specific project documentation,
wherein the job-specific project documentation further comprises job-specific construction project documentation,
wherein the graphic document further comprises a device-independent document,
wherein the device-independent document further comprises a form-fillable device-independent document.

17. The computer-accessible medium of claim 10, wherein the reviewer further comprises a contractor.

18. The computer-accessible medium of claim 6, wherein the job-specific information further comprises:
job-specific project documentation.

19. The computer-accessible medium of claim 17, wherein the job-specific project documentation further comprises:
job-specific construction project documentation.

20. The computer-accessible medium of claim 6, wherein the graphic document further comprises:
a device-independent document.

21. The computer-accessible medium of claim 19, wherein the device-independent document further comprises:
a form-fillable device-independent document.

22. A computer-accessible medium having executable instructions to prepare project information for exchange in a predetermined architecture of graphic document interchange, the executable instructions capable of directing a processor to perform:
receiving project documentation to a computer-accessible medium;
receiving at least one graphic document to the computer-accessible medium;
adding job-specific information to a plurality of graphic documents, the plurality of graphic documents having a file name in accordance with a standardized documentation nomenclature, the adding being performed upon each of the plurality of graphic documents by a materials originator; wherein the plurality of graphic documents are added by a plurality of material originators; and
determining a disposition of each of the plurality of graphic documents in reference to the job-specific information in each of the plurality of graphic documents.

23. The computer-accessible medium of claim 22, wherein the executable instructions further comprise executable instructions capable of directing the processor to perform:
aggregating the plurality of graphic documents into a folder data structure, the folder data structure being on a computer-accessible medium, and the aggregating being performed by an aggregator; and
delivering each of the disposed plurality of graphic documents and the disposition of each of the disposed plurality of graphic documents to the one of the plurality of material originators that added the job-specific information to the graphic document.

24. The computer-accessible medium of claim 22, wherein the graphic document further comprises:
a form-fillable device-independent document.

25. A computer-accessible medium to exchange project information in a predetermined architecture of multimedia object interchange between heterogeneous computer systems, the medium comprising:
a receiver of project documentation that is operable to store the project documentation to a computer-accessible medium;
a receiver of at least one multimedia object that is operable to store the at least one multimedia object to a computer-accessible medium; and
a combiner of the at least one multimedia object and the project documentation, wherein the combined at least one multimedia object and project documentation provides for an encapsulation of the at least one multimedia object and project documentation that in turn results an organization of the at least one multimedia object and project documentation organization that increases the ease and readiness at which the at least one multimedia object and project documentation can be integrated in systemic architecture of workflow of multimedia objects between heterogeneous computer systems.

26. The computer-accessible medium of claim 26, wherein the receiver of project documentation and the receiver of at least one multimedia object further comprises:
the receiver of project documentation and the receiver of at least one multimedia object are operable in any order.

27. The computer-accessible medium of claim 26, wherein the receiver of project documentation and the receiver of at least one multimedia object further comprises:
the receiver of project documentation and the receiver of at least one multimedia object are operable simultaneously.

28. The computer-accessible medium of claim 22, wherein the at least one multimedia object further comprises:
a form-fillable device-independent document.

29. A computer-accessible medium having executable instructions to prepare construction project information for exchange in a predetermined architecture of multimedia object interchange, the executable instructions capable of directing a processor to perform:
receiving construction project documentation to a computer-accessible medium;
receiving at least one multimedia object to the computer-accessible medium; and
combining the at least one multimedia object with the construction project documentation.

30. The computer-accessible medium of claim 28, wherein the executable instructions capable of directing the processor to perform the receiving construction project documentation further comprise executable instructions capable of directing the processor to perform:
downloading the construction project documentation.

31. The computer-accessible medium of claim 1, wherein the multimedia object further comprises:
a PDF document.

32. The computer-accessible medium of claim 31, wherein the PDF document further comprises:
a form-fillable PDF document.

33. A computer-accessible medium having executable instructions to exchange PDF documents, the executable instructions capable of directing a processor to perform:
adding job-specific information to a plurality of PDF documents, the plurality of PDF documents having a file name in accordance with a standardized documentation nomenclature, the adding being performed upon each of the plurality of PDF documents by a materials originator; wherein the plurality of PDF documents are added by a plurality of sub-contractors;
aggregating the plurality of PDF documents into a folder data structure, the folder data structure being on a computer-accessible medium, and the aggregating being performed by a general contractor;
determining an acceptance or rejection of each of the plurality of PDF documents in reference to the job-specific information in each of the plurality of PDF documents; and
delivering each of the disposed plurality of PDF documents and the acceptance or rejection of each of the disposed plurality of PDF documents to the one of the plurality of sub-contractors that added the job-specific information to the PDF document.

34. The computer-accessible medium of claim 33, wherein the executable instructions capable of directing the processor to deliver further comprise:
delivering each of the disposed plurality of PDF documents and the acceptance or rejection of each of the disposed plurality of PDF documents to the general contractor.

35. The computer-accessible medium of claim 33, wherein the executable instructions capable of directing the processor to add the job-specific information to the plurality of PDF documents further comprise executable instructions capable of directing the processor to perform:
for each of the PDF documents of one of the plurality of materials originator:
receiving an indication from an operator of a computer of an item in the standardized documentation nomenclature;
displaying a PDF document of the item;
receiving the job-specific information from the operator;
modifying the PDF document by addition of the job-specific information of the job-specific information to the PDF document;
adding a submittal page to the PDF document; and
storing the PDF document in the folder data structure on the computer-accessible medium with the file name in accordance with the item in the standardized documentation nomenclature, and
delivering the folder of the PDF documents to the general contractor.

36. The computer-accessible medium of claim 33, wherein the executable instructions capable of directing the processor to aggregate the plurality of PDF documents further comprise executable instructions capable of directing the processor to perform:
receiving at least one folder of PDF documents from each of the plurality of materials originators;
aggregating the folders into a project folder data structure, the project folder data structure being on a computer-accessible medium, and the aggregating being performed by the general contractor; and
delivering the parent folder of the PDF documents to a licensed architect.

37. The computer-accessible medium of claim 33, wherein the executable instructions capable of directing the processor to determine the acceptance or rejection of each of the plurality of PDF documents further comprise executable instructions capable of directing the processor to perform:
receiving a project folder from the general contractor;
for each PDF document in the project folder:
presenting the PDF document to a licensed architect;
receiving an acceptance or rejection of the PDF document;
associating the acceptance or rejection with the PDF document; and
storing the PDF document in a folder associated with rejection or saving the PDF document in a folder associated with acceptance depending on the acceptance or rejection,
delivering the folder associated with rejection and the folder associated with acceptance.

38. The computer-accessible medium of claim 37, wherein the executable instructions capable of directing the processor to associate the acceptance or rejection with the PDF document further comprise executable instructions capable of directing the processor to perform:
modifying the PDF document with the acceptance or rejection.

39. The computer-accessible medium of claim 37, wherein the executable instructions capable of directing the processor to deliver the folder associated with rejection and the folder associated with acceptance further comprise executable instructions capable of directing the processor to perform:
delivering to a sub-contractor the folder associated with rejection and the folder associated with acceptance.

40. The computer-accessible medium of claim 37, wherein the executable instructions capable of directing the processor to deliver the folder associated with rejection acceptance or rejection further comprise executable instructions capable of directing the processor to perform:
delivering to the general contractor the folder associated with rejection; and
delivering to the general contractor the folder associated with acceptance.

41. The computer-accessible medium of claim 37, wherein the executable instructions capable of directing the processor to deliver the folder associated with rejection and the folder associated with acceptance further comprise executable instructions capable of directing the processor to perform:
delivering to the general contractor and a sub-contractor the folder associated with rejection, and
delivering to the general contractor and a sub-contractor the folder associated with acceptance.

42. The computer-accessible medium of claim 37, wherein the executable instructions further comprise executable instructions capable of directing the processor to perform:
comparing transmittal file to file in the reject/accept folder of the project folder depending upon acceptance or rejection, and save in a folder in reference to the acceptance or rejection.

43. The computer-accessible medium of claim 33, wherein the job-specific information further comprises:
job-specific project documentation.

44. The computer-accessible medium of claim 43, wherein the job-specific project documentation further comprises:
job-specific construction project documentation.

45. The computer-accessible medium of claim 33, wherein the PDF document further comprises:
a PDF document.

46. The computer-accessible medium of claim 45, wherein the PDF document further comprises:
a form-fillable PDF document.

47. A computer-accessible medium having executable instructions to prepare project information for exchange in a predetermined architecture of PDF document interchange, the executable instructions capable of directing a processor to perform:
receiving project documentation to a computer-accessible medium;
receiving at least one PDF document to the computer-accessible medium;
adding job-specific information to a plurality of PDF documents, the plurality of PDF documents having a file name in accordance with a standardized documentation nomenclature, the adding being performed upon each of the plurality of PDF documents by a materials originator; wherein the plurality of PDF documents are added by a plurality of sub-contractors; and
determining an acceptance or rejection of each of the plurality of PDF documents in reference to the job-specific information in each of the plurality of PDF documents.

48. The computer-accessible medium of claim 47, wherein the executable instructions further comprise executable instructions capable of directing the processor to perform:
aggregating the plurality of PDF documents into a folder data structure, the folder data structure being on a computer-accessible medium, and the aggregating being performed by a general contractor; and
delivering each of the disposed plurality of PDF documents and the acceptance or rejection of each of the disposed plurality of PDF documents to the one of the plurality of sub-contractors that added the job-specific information to the PDF document.

49. The computer-accessible medium of claim 47, wherein the PDF document further comprises:
a form-fillable PDF document.

50. A computer-accessible medium to exchange project information in a predetermined architecture of multimedia object interchange between heterogeneous computer systems, the medium comprising:
a receiver of construction project documentation that is operable to store the construction project documentation to a computer-accessible medium;
a receiver of at least one multimedia object that is operable to store the at least one multimedia object to a computer-accessible medium; and
a combiner of the at least one multimedia object and the construction project documentation, wherein the combined at least one multimedia object and construction project documentation provides for an encapsulation of the at least one multimedia object and construction project documentation that in turn results an organization of the at least one multimedia object and construction project documentation organization that increases the ease and readiness at which the at least one multimedia object and construction project documentation can be integrated in systemic architecture of workflow of multimedia objects between heterogeneous computer systems.

51. The computer-accessible medium of claim 50, wherein the receiver of construction project documentation and the receiver of at least one multimedia object further comprises:
the receiver of construction project documentation and the receiver of at least one multimedia object are operable in any order.

52. The computer-accessible medium of claim 50, wherein the receiver of construction project documentation and the receiver of at least one multimedia object further comprises:
the receiver of construction project documentation and the receiver of at least one multimedia object are operable simultaneously.

53. The computer-accessible medium of claim 50, wherein the at least one multimedia object further comprises:
a form-fillable PDF document.
